(19) United States
(12) Patent Application Publication
(10) Pub. No.: US 2025/0184261 A1
(43) Pub. Date: Jun. 5, 2025

(54) METHOD FOR POLICY CONTROL FUNCTION (PCF) AND PCF

(71) Applicant: NEC Corporation, Minato-ku, Tokyo (JP)

(72) Inventors: Toshiyuki Tamura, Tokyo (JP); Kundan Tiwari, Tokyo (JP); Iskren Ianev, Tokyo (JP)

(73) Assignee: NEC Corporation, Minato-ku, Tokyo (JP)

(21) Appl. No.: 18/841,501

(22) PCT Filed: Mar. 17, 2023
(86) PCT No.: PCT/JP2023/010546

§ 371 Date: Aug. 26, 2024

(30) Foreign Application Priority Data
Mar. 24, 2022 (IN) 202211016661

(51) Int. Cl. H04L 45/302; H04W 48/18

(52) U.S. Cl. CPC H04L 45/306; H04L 45/308; H04W 48/18

(57) ABSTRACT

Please delete the Abstract of the Disclosure, and replace it with the following: In the current 3GPP standard(s), there is no mechanism or procedure for Key issue. This disclosure provides a solution to this key issue. A method for a User Plane Function (UPF) includes receiving, from a core network node, at least one of Users Equipment ID (UE ID), Data Network Name (DNN), Single-Network Slice Selection Assistance Information (S-NSSAI) and information related to UE Route Selection Policy rule (URSP). The method includes checking whether user data for a User Equipment (UE) using a User Equipment (UE) session with the DNN and S-NSSAI matches the information related to UE Route Selection Policy rule (URSP) or not. The method includes sending to the core network node a result of the checking.

### TECHNICAL FIELD

The present disclosure relates to a method for a User Plane Function (UPF) and a UPF.

### BACKGROUND ART

In SA2 #149e meeting, NPL 2 describes Key Issue: 5GC awareness of URSP enforcement under the Study item on Enhancement of 5G UE Policy. This agreed Key issue includes the following items to be studied.

Whether and how the 5GC can be made aware whether or when the UE enforces a URSP rule to route an application traffic to a PDU Session based on the URSP rule provisioned by 5GC.

Whether there are any actions the 5GS can take after 5GC is aware whether the UE enforces a URSP rule for specific application traffic or not. If any, what action 5GC should take?

### CITATION LIST

### Non Patent Literature

[NPL 1]3GPP TR 21.905: “Vocabulary for 3GPP Specifications”. V17.1.0 (2021-12)
[NPL 2]S2-2201363 https://www.3gpp.org/ftp/tsg_sa/WG2_Arch/TSGS2_149E_Electron ic_2022-02/Docs/52-2201363.zip
[NPL 3]3GPP TS 23.501: “System architecture for the 5G System (5GS)”. V17.3.0 (2021-12)
[NPL 4]3GPP TS 23.502: “Procedures for the 5G System (5GS)”. V17.3.0 (2021-12)
[NPL 5]3GPP TS 23.503: “Policy and charging control framework for the 5G System (5GS) Stage 2”. V17.3.0 (2021-12)
[NPL 6] IETF RFC 5905: “Network Time Protocol Version 4: Protocol and Algorithms Specification” https://datatracker.ietf.org/doc/html/rfc5905
[NPL 7]3GPP TS 38.413: NG-RAN; NG Application Protocol (NGAP). V16.8.0 (2021-12).

### SUMMARY OF INVENTION

### Technical Problem

In the current 3GPP standard(s), there is no mechanism or procedure for the above Key issue.

This disclosure provides a solution to this key issue. For example, this disclosure provides a mechanism or procedure for this key issue.

### Solution to Problem

In an aspect of the present disclosure, a method for a User Plane Function (UPF) includes receiving, from a core network node, at least one of Users Equipment ID (UE ID), Data Network Name (DNN), Single-Network Slice Selection Assistance Information (S-NSSAI) and information related to UE Route Selection Policy rule (URSP). The method includes checking whether user data for a User Equipment (UE) using a User Equipment (UE) session with the DNN and S-NSSAI matches the information related to UE Route Selection Policy rule (URSP) or not. The method includes sending to the core network node a result of the checking.

In an aspect of the present disclosure, a User Plane Function (UPF) includes a memory and at least one processor configured to access the memory and configured to receive, from a core network node, at least one of Users Equipment ID (UE ID), Data Network Name (DNN), Single-Network Slice Selection Assistance Information (S-NSSAI) and information related to UE Route Selection Policy rule (URSP), check whether user data for a User Equipment (UE) using a User Equipment (UE) session with the DNN and S-NSSAI matches the information related to UE Route Selection Policy rule (URSP) or not, and send to the core network node a result of the check.

### BRIEF DESCRIPTION OF DRAWINGS

FIG. 1 is a signaling diagram of a First example of the First Aspect (UE policy checked by the AMF).

FIG. 2 is a signaling diagram of a Second example of the First Aspect (UE policy checked by the SMF).

FIG. 3 is a signaling diagram of a Third example of the First Aspect (UE policy checked by the UPF).

FIG. 4 is a signaling diagram of a Fourth example of the First Aspect (UE policy checked by the AMF for existing PDU session (UE triggered)).

FIG. 5 is a signaling diagram of a Fifth example of the First Aspect (UE policy checked by the AMF for existing PDU session (AMF triggered)).

FIG. 6 is a diagram illustrating a system overview.

FIG. 7 is a block diagram illustrating a User equipment (UE).

FIG. 8 is a block diagram illustrating an (R)AN node.

FIG. 9 is a diagram illustrating System overview of (R)AN node based on O-RAN architecture.

FIG. 10 is a block diagram illustrating a Radio Unit (RU).

FIG. 11 is a block diagram illustrating a Distributed Unit (DU).

FIG. 12 is a block diagram illustrating a Centralized Unit (CU).

FIG. 13 is a block diagram illustrating an Access and Mobility Management Function (AMF).

FIG. 14 is a block diagram illustrating a Session Management Function (SMF).

FIG. 15 is a block diagram illustrating a User Plane Function (UPF).

FIG. 16 is a block diagram illustrating a Policy Control Function (PCF).

FIG. 17 is a block diagram illustrating an Authentication Server Function (AUSF).

FIG. 18 is a block diagram illustrating a Unified Data Management (UDM).

FIG. 19 illustrates UE's URSP enforcement validation by the network.

### DESCRIPTION OF EMBODIMENTS

### Abbreviations

For the purposes of the present document, the abbreviations given in NPL 1 and the following apply. An abbreviation defined in the present document takes precedence over the definition of the same abbreviation, if any, in NPL 1.

4G-GUTI 4G Globally Unique Temporary UE Identity

5GC 5G Core Network

5GLAN 5G Local Area Network

5GS 5G System

5G-AN 5G Access Network

5G-AN PDB 5G Access Network Packet Delay Budget

5G-EIR 5G-Equipment Identity Register

5G-GUTI 5G Globally Unique Temporary Identifier

5G-BRG 5G Broadband Residential Gateway

5G-CRG 5G Cable Residential Gateway

5G GM 5G Grand Master

5G-RG 5G Residential Gateway

5G-S-TMSI 5G S-Temporary Mobile Subscription Identifier

5G VN 5G Virtual Network

5QI 5G QoS Identifier

AF Application Function

AMF Access and Mobility Management Function

AMF-G Geographically selected Access and Mobility Management Function

AMF-NG Non-Geographically selected Access and Mobility Management Function

ANDSF Access Network Discovery and Selection Function AS Access Stratum

ATSSS Access Traffic Steering, Switching, Splitting

ATSSS-LL ATSSS Low-Layer

AUSF Authentication Server Function

AUTN Authentication token

BCCH Broadcast Control Channel

BMCABest Master Clock Algorithm

BSF Binding Support Function

CAG Closed Access Group

CAPIF Common API Framework for 3GPP northbound APIs

CHF Charging Function

CN PDB Core Network Packet Delay Budget

CP Control Plane

DAPS Dual Active Protocol Stacks

DL Downlink

DN Data Network

DNAI DN Access Identifier

DNN Data Network Name

DRX Discontinuous Reception

DS-TT Device-side TSN translator

ePDG evolved Packet Data Gateway

EBI EPS Bearer Identity

EPS Evolved Packet System

EUI Extended Unique Identifier

FAR Forwarding Action Rule

FN-BRG Fixed Network Broadband RG

FN-CRG Fixed Network Cable RG

FN-RG Fixed Network RG

FQDN Fully Qualified Domain Name

GFBR Guaranteed Flow Bit Rate

GMLCGateway Mobile Location Centre

GPSI Generic Public Subscription Identifier

GUAMI Globally Unique AMF Identifier

GUTI Globally Unique Temporary UE Identity

HPLMN Home Public Land Mobile Network

HR Home Routed (roaming)

IAB Integrated access and backhaul

IMEI/TAC IMEI Type Allocation Code

IPUPSInter PLMN UP Security

I-SMF Intermediate SMF

I-UPF Intermediate UPF

LADN Local Area Data Network

LBO Local Break Out (roaming)

LMF Location Management Function

LoA Level of Automation

LPP LTE Positioning Protocol

LRF Location Retrieval Function

MCC Mobile country code

MCX Mission Critical Service

MDBV Maximum Data Burst Volume

MFBR Maximum Flow Bit Rate

MICO Mobile Initiated Connection Only

MITM Man In the Middle

MNC Mobile Network Code

MPS Multimedia Priority Service

MPTCP Multi-Path TCP Protocol

N3IWF Non-3GPP InterWorking Function

N3GPP Non-3GPP access

N5CWNon-5G-Capable over WLAN

NAI Network Access Identifier

NAS Non-Access-Stratum

NEF Network Exposure Function

NF Network Function

NGAP Next Generation Application Protocol

NID Network identifier

NPN Non-Public Network

NR New Radio

NRF Network Repository Function

NSI ID Network Slice Instance Identifier

NSSAA Network Slice-Specific Authentication and Authorization

NSSAAF Network Slice-Specific Authentication and Authorization Function

NSSAI Network Slice Selection Assistance Information

NSSF Network Slice Selection Function

NSSP Network Slice Selection Policy

NSSRG Network Slice Simultaneous Registration Group

NW-TT Network-side TSN translator

NWDAF Network Data Analytics Function

PCF Policy Control Function

PCO Protocol Configuration Options

PDB Packet Delay Budget

PDR Packet Detection Rule

PDU Protocol Data Unit

PEI Permanent Equipment Identifier

PER Packet Error Rate

PFD Packet Flow Description

PLMN Public Land Mobile Network

PNI-NPN Public Network Integrated Non-Public Network

PPD Paging Policy Differentiation

PPF Paging Proceed Flag

PPI Paging Policy Indicator

PSA PDU Session Anchor

PTP Precision Time Protocol

QFI QoS Flow Identifier

QoE Quality of Experience

RACS Radio Capabilities Signalling optimisation

(R)AN(Radio) Access Network

RAT Radio Access Technology

RG Residential Gateway

RIM Remote Interference Management

RQA Reflective QoS Attribute

RQI Reflective QoS Indication

RSN Redundancy Sequence Number

SA NR Standalone New Radio

SBA Service Based Architecture

SBI Service Based Interface

SCP Service Communication Proxy

SD Slice Differentiator

SEAF Security Anchor Functionality

SEPP Security Edge Protection Proxy

SMF Session Management Function

SMSF Short Message Service Function

SN Sequence Number

SN name Serving Network Name.

SNPN Stand-alone Non-Public Network

S-NSSAI Single Network Slice Selection Assistance Information

SSC Session and Service Continuity

SSCMSP Session and Service Continuity Mode Selection Policy

SST Slice/Service Type

SUCI Subscription Concealed Identifier

SUPI Subscription Permanent Identifier

SV Software Version

TMSI Temporary Mobile Subscriber Identity

TNAN Trusted Non-3GPP Access Network

TNAP Trusted Non-3GPP Access Point

TNGF Trusted Non-3GPP Gateway Function

TNL Transport Network Layer

TNLA Transport Network Layer Association

TSC Time Sensitive Communication

TSCAI TSC Assistance Information

TSN Time Sensitive Networking

TSN GM TSN Grand Master

TSP Traffic Steering Policy

TT TSN Translator

TWIF Trusted WLAN Interworking Function

UCMF UE radio Capability Management Function

UDM Unified Data Management

UDR Unified Data Repository

UDSF Unstructured Data Storage Function

UE User Equipment

UL Uplink

UL CL Uplink Classifier

UPF User Plane Function

UPSI UE Policy Section Identifier

URLLC Ultra Reliable Low Latency Communication

URRP-AMF UE Reachability Request Parameter for AMF

URSP UE Route Selection Policy

VID VLAN Identifier

VLAN Virtual Local Area Network

VPLMN Visited Public Land Mobile Network

W-5GAN Wireline 5G Access Network

W-5GBAN Wireline BBF Access Network

W-5GCAN Wireline 5G Cable Access Network

W-AGF Wireline Access Gateway Function

### Definitions

For the purposes of the present document, the terms and definitions given in NPL 1 and the following apply. A term defined in the present document takes precedence over the definition of the same term, if any, in NPL 1.

### General

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

Each of Aspects and elements included in each Aspects described below may be implemented independently or in combination with any other. These Aspects include novel characteristics different from one another. Accordingly, these Aspects contribute to achieving objects or solving problems different from one another and contribute to obtaining advantages different from one another.

An example object of this disclosure is to provide a method and apparatus that can solve the above problem.

For example, the Policy Control Function (PCF) provides to a UE policy for PDU Session selection for example, i.e. UE Route Selection Policy (URSP). For example, this policy is used by the UE to determine how to route outgoing traffic from the Applications in the UE. For example, for the existing PDU Session(s), the UE examines the URSP rule(s) within the UE policy information in order to determine whether the existing PDU Session(s) can be reused.

However, for example, currently there is no solutions in the 3GPP specification(s) (or the 3GPP standard(s)) which can prevent unauthorized application(s) in the UE.

A method of a communication apparatus according to example aspect of this disclosure includes receiving a policy for a user equipment (UE). The method includes receiving information related to an application in the UE from the UE. The method includes checking whether the information is consistent with the policy. The method includes sending a reject message in a case where the information is not consistent with the policy.

A method of a user equipment (UE) according to example aspect of this disclosure includes sending a first message. The first message includes first information related to an application in the UE. The method includes receiving a second message after sending the first message. The second message includes second information. The second information indicates that the application is rejected. The method includes stopping use of the application in a case of receiving the second message.

A method of a communication apparatus according to example aspect of this disclosure includes receiving a policy for a user equipment (UE) and information indicating that checking of data of the UE is needed. The method includes checking whether the data is consistent with the policy after receiving the information. The method includes performing deactivation of communication related to the data in a case where the data is not consistent with the policy.

A method of a communication apparatus according to example aspect of this disclosure includes receiving a policy for a user equipment (UE). The method includes receiving a service request message. The service request message includes an identifier of an application in the UE. The method includes checking whether the identifier is consistent with the policy. The method includes sending an accept message in a case where the identifier is consistent with the policy. The method includes sending a reject message in a case where the identifier is not consistent with the policy.

A method of a user equipment (UE) according to example aspect of this disclosure includes sending a service request message in a case where the UE has an established PDU session. The service request message includes an identifier of an application in the UE. The method includes receiving a first message after sending the service request message. The method includes sending data in a case where the first message is an accept message. The method includes stopping use of the application in a case where the first message is a reject message.

A method of a communication apparatus according to example aspect of this disclosure includes receiving a policy for a user equipment (UE). The method includes sending a request to send an identifier of an application in the UE. The method includes receiving the identifier. The method includes checking whether the identifier is consistent with the policy. The method includes sending a message after checking whether the identifier is consistent with the policy. The message includes at least one of information indicating an application to be allowed and information indicating an application to be not allowed.

A method of a user equipment (UE) according to example aspect of this disclosure includes receiving a request to send an identifier of an application in the UE. The method includes sending the identifier. The method includes receiving a message after sending the identifier. The message includes at least one of information indicating an application to be allowed and information indicating an application to be not allowed. The method includes stopping use of the application to be not allowed after receiving the message.

A communication apparatus according to example aspect of this disclosure includes a memory, and at least one hardware processor coupled to the memory. The at least one hardware processor is configured to receive a policy for a user equipment (UE). The at least one hardware processor is configured to receive information related to an application in the UE from the UE. The at least one hardware processor is configured to check whether the information is consistent with the policy. The at least one hardware processor is configured to send a reject message in a case where the information is not consistent with the policy.

A user equipment (UE) according to example aspect of this disclosure includes a memory, and at least one hardware processor coupled to the memory. The at least one hardware processor is configured to send a first message. The first message includes first information related to an application in the UE. The at least one hardware processor is configured to receive a second message after sending the first message. The second message includes second information. The second information indicates that the application is rejected. The at least one hardware processor is configured to stop use of the application in a case of receiving the second message.

A communication apparatus according to example aspect of this disclosure includes a memory, and at least one hardware processor coupled to the memory. The at least one hardware processor is configured to receive a policy for a user equipment (UE) and information indicating that checking of data of the UE is needed. The at least one hardware processor is configured to check whether the data is consistent with the policy after receiving the information. The at least one hardware processor is configured to perform deactivation of communication related to the data in a case where the data is not consistent with the policy.

A communication apparatus according to example aspect of this disclosure includes a memory, and at least one hardware processor coupled to the memory. The at least one hardware processor is configured to receive a policy for a user equipment (UE). The at least one hardware processor is configured to receive a service request message. The service request message includes an identifier of an application in the UE. The at least one hardware processor is configured to check whether the identifier is consistent with the policy. The at least one hardware processor is configured to send an accept message in a case where the identifier is consistent with the policy. The at least one hardware processor is configured to send a reject message in a case where the identifier is not consistent with the policy.

A user equipment (UE) according to example aspect of this disclosure includes a memory, and at least one hardware processor coupled to the memory. The at least one hardware processor is configured to send a service request message in a case where the UE has an established PDU session. The service request message includes an identifier of an application in the UE. The at least one hardware processor is configured to receive a first message after sending the service request message. The at least one hardware processor is configured to send data in a case where the first message is an accept message. The at least one hardware processor is configured to stop use of the application in a case where the first message is a reject message.

A communication apparatus according to example aspect of this disclosure includes a memory, and at least one hardware processor coupled to the memory. The at least one hardware processor is configured to receive a policy for a user equipment (UE). The at least one hardware processor is configured to send a request to send an identifier of an application in the UE. The at least one hardware processor is configured to receive the identifier. The at least one hardware processor is configured to check whether the identifier is consistent with the policy. The at least one hardware processor is configured to send a message after checking whether the identifier is consistent with the policy. The message includes at least one of information indicating an application to be allowed and information indicating an application to be not allowed.

A user equipment (UE) according to example aspect of this disclosure includes a memory, and at least one hardware processor coupled to the memory. The at least one hardware processor is configured to receive a request to send an identifier of an application in the UE. The at least one hardware processor is configured to send the identifier. The at least one hardware processor is configured to receive a message after sending the identifier. The message includes at least one of information indicating an application to be allowed and information indicating an application to be not allowed. The at least one hardware processor is configured to stop use of the application to be not allowed after receiving the message.

A method of a first apparatus according to example aspect of this this disclosure includes receiving, from a second apparatus, policy information for a communication terminal. The method includes receiving, from the communication terminal, information for an application for the communication terminal. The method includes checking, whether the information for an application for the communication terminal is consistent with the policy information for a communication terminal. The method includes sending, to the communication terminal, information related to rejection in a case where the information for an application for the communication terminal is not consistent with the policy information for a communication terminal.

A method of a third apparatus according to example aspect of this this disclosure includes storing policy information for a communication terminal from a second apparatus. The method includes receiving, from the communication terminal, information for an application for the communication terminal. The method includes checking, whether the information for an application for the communication terminal is consistent with the policy information for a communication terminal. The method includes sending, to a first apparatus, information related to rejection in a case where the information for an application for the communication terminal is not consistent with the policy information for a communication terminal.

A method of a fourth apparatus according to example aspect of this this disclosure includes storing policy information for a communication terminal from a second apparatus. The method includes receiving, from a third apparatus for session management, information for an application for the communication terminal. The method includes receiving, from the third apparatus for session management, information indicates checking data related to a communication terminal is needed. The method includes checking, whether the information for an application for the communication terminal is consistent with the policy information for a communication terminal based on the information indicates checking data related to the communication terminal is needed. The method includes sending information related to rejection in a case where the information for an application for the communication terminal is not consistent with the policy information for a communication terminal.

A method of a communication terminal according to example aspect of this this disclosure includes sending, to a first apparatus, a service request message including information for an application for the communication terminal, wherein the first apparatus storing policy information for a communication terminal from a second apparatus, wherein the first apparatus checking, whether the information for an application for the communication terminal is consistent with the policy information for a communication terminal, wherein the first apparatus sending, to the communication terminal information related to rejection in a case where the information for an application for the communication terminal is not consistent with the policy information for a communication terminal.

A method of a communication terminal according to example aspect of this this disclosure includes sending, to a first apparatus, service request message including information for an application for the communication terminal, wherein the first apparatus storing policy information for a communication terminal from a second apparatus, wherein the first apparatus checking, whether the information for an application for the communication terminal is consistent with the policy information for a communication terminal wherein the first apparatus sending information, to the communication terminal, related to acceptance in a case where the information for an application for the communication terminal is consistent with the policy information for a communication terminal.

A method of a first apparatus according to example aspect of this this disclosure includes storing policy information for a communication terminal from a second apparatus. The method includes receiving, from the communication terminal, service request message including information for an application for the communication terminal. The method includes checking, whether the information for an application for the communication terminal is consistent with the policy information for a communication terminal. The method includes sending, to the communication terminal, information related to rejection in a case where the information for an application for the communication terminal is not consistent with the policy information for a communication terminal.

A method of a first apparatus according to example aspect of this this disclosure includes storing policy information for a communication terminal from a second apparatus. The method includes receiving, from the communication terminal, service request message including information for an application for the communication terminal. The method includes checking, whether the information for an application for the communication terminal is consistent with the policy information for a communication terminal. The method includes sending, to the communication terminal, information related to acceptance in a case where the information for an application for the communication terminal is consistent with the policy information for a communication terminal.

A method of a first apparatus according to example aspect of this this disclosure includes storing policy information for a communication terminal from a second apparatus. The method includes sending, to the communication terminal, a request message for information for an application for the communication terminal. The method includes receiving, from the communication terminal, the information for an application for the communication terminal. The method includes checking, whether the information for an application for the communication terminal is consistent with the policy information for the communication terminal. The method includes sending, to the communication terminal, information related to rejection in a case where the information for an application for the communication terminal is not consistent with the policy information for the communication terminal.

A method of a first apparatus according to example aspect of this this disclosure includes storing policy information for a communication terminal from a second apparatus. The method includes sending, to the communication terminal, a request message for information for an application for the communication terminal. The method includes receiving, from the communication terminal, the information for an application for the communication terminal. The method includes checking, whether the information for an application for the communication terminal is consistent with the policy information for the communication terminal. The method includes sending, to the communication terminal, information related to acceptance in a case where the information for an application for the communication terminal is consistent with the policy information for the communication terminal.

### <First Aspect>

This aspect discloses, for example, a method of network verification of whether a UE applies correctly the URSP rule(s) provisioned by a core network.

### First Example of the First Aspect

A First example of the First Aspect discloses a method where a PCF 73 sends the UE policy to an AMF 70 when the AMF 70 establishes a UE Policy association with the PCF73. Then the AMF 70 checks a requested PDU session from a UE 3 whether the request from the UE 3 is consistent with the latest UE policy provisioned to the UE 3 from the PCF 73.

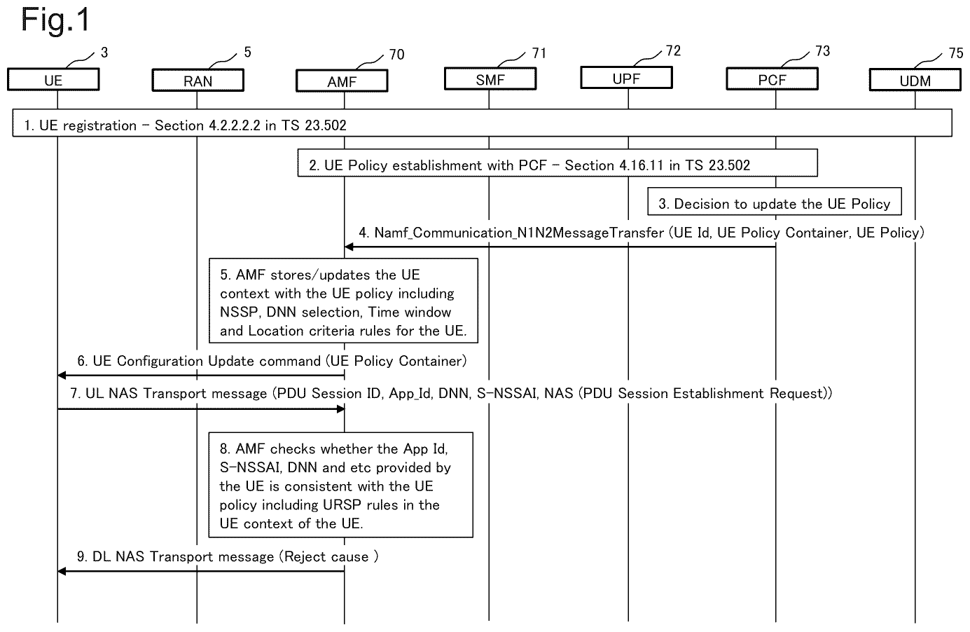

The detailed processes of the First example of the First Aspect are described below, with reference to FIG. 1.
Step 1: The UE 3 performs the registration procedure as defined in section 4.2.2.2.2 in NPL 4.
Step 2: During the registration procedure or after the registration procedure, the UE policy establishment with PCF procedure takes place with the PCF 73. This process may be performed on the basis of 4.16.11 in NPL 4.
Step 3: The PCF 73 decides to update the UE policy or part of the UE policy, e.g. the UE policy rule(s) that have been updated since the last UE update with the UE policy. For example, the PCF 73 may decide to update the UE policy based on local configuration in the PCF 73. For example, the PCF 73 may decide to update the UE policy in a case where a new UE policy is created and the previous UE policy needs to be updated by the new UE policy. The new UE policy may be created by the PCF 73.
Step 4: The PCF 73 sends an Namf_Communication_N1N2MessageTransfer message to the AMF 70 or any other existing or new message on the interface between the PCF 73 and the AMF 70 in which the PCF 73 includes a UE ID, a UE Policy container and the UE policy as a separate parameter. The UE policy may contain the same data as the data in the UE Policy container. The UE ID may be an identifier of the UE 3. At least one of the UE Policy container and the UE policy may be referred to as UE Policy information or UE policy rule(s). The PCF 73 may send the Namf_Communication_N1N2MessageTransfer message in a case where the PCF 73 decides to update the UE policy or part of the UE policy. The PCF 73 may send the Namf_Communication_N1N2MessageTransfer message periodically.
Step 5: Upon reception of the Namf_Communication_N1N2MessageTransfer message from the PCF 73 in step 4 or any other message from the PCF 73 that carries the UE Policy information, the AMF 70 stores or updates the UE context with the received UE policy from the PCF 73. The UE policy may include NSSP, DNN selection, Time window and Location criteria, and other information as defined in the URSP rule(s) in NPL 5].
Step 6: Upon reception of the Namf_Communication_N1N2MessageTransfer message from the PCF 73 in step 4, the AMF 70 sends a UE Configuration Update command message to the UE 3 including the UE policy container. The UE policy container in step 6 may be same to one received in step 4. Step 5 may be performed after step 6.
Step 7: At some point, the UE 3 sends a UL NAS Transport message to the AMF 70 including PDU Session ID, App_Id, DNN, S-NSSAI and NAS container that includes PDU Session Establishment Request to establish a PDU session or Service Request message or any other NAS message with the purpose of establishing a new PDU Session or with the purpose to re-use an already established PDU Session or modify the already established PDU Session. In this disclosure, the App_Id may be used to identify Application(s) that is(are) running on the UE 3's OS. In this disclosure, the App_Id may be used to identify Application(s) that is(are) running on the UE 3. In this disclosure, the DNN and the S-NSSAI in the UL NAS Transport message may be DNN and S-NSSAI that the UE 3 or the UE 3's Application(s) requests to use.
Step 8: Upon reception of the UL NAS Transport message from the UE 3, the AMF 70 checks whether at least one of the App_Id, S-NSSAI, DNN and other information etc provided by the UE 3 are consistent or matches with the UE policy rule(s) stored in the UE context for the UE 3 within the AMF 70. The UE policy rule(s) stored in the UE context for the UE 3 within the AMF 70 may be the UE policy stored in step 4.

When the AMF 70 checks whether at least one of the App_Id etc. provided by the UE 3 is consistent with the UE policy, the AMF 70 may check the UE policy or the URSP rule(s) corresponding to the PDU Session ID received in step 7.
Step 9: If the AMF 70 finds that at least one of the received parameter(s) in the UL NAS Transport message or any other NAS message is not consistent with the UE policy rule(s) for the UE 3 (for example, if the received application identity (i.e., the App_Id) does not match any route descriptor rule(s) defined in the NSSP corresponding to the application identity or if the received App_Id does not match any application identities in the URSP rule(s) or if the received App_Id does not match any application identities in “Application descriptors” of the URSP rule(s)), then the AMF 70 sends a DL NAS Transport message or any other NAS message to the UE 3 in which the AMF 70 includes a reject cause parameter. Otherwise (e.g. if the AMF 70 finds that at least one of the received parameter(s) in the UL NAS Transport message or any other NAS message is consistent with the UE policy rule(s) for the UE 3), the AMF 70 continues with the PDU Session establishment procedure as per TS23.502, clause 4.3.2.2.1. If the PDU Session Establishment Request is rejected or if the AMF 70 finds that at least one of the received parameter(s) in the UL NAS Transport message or any other NAS message is not consistent with the UE policy rule(s) for the UE 3, the reject cause parameter in the NAS message to the UE 3 or the DL NAS Transport message or any other NAS message may have one value or multiple values from the reject causes listed below. They may be 5GMM causes. The reject cause may be correspond to the App_Id received from the UE 3 in step 7.
   S-NSSAI not allowed or Application on the S-NSSAI not allowed (i.e. the Application with App_Id is not allowed service(s) on the S-NSSAI) or any other notation for a reject cause in order to indicate to the UE 3 that the Application in the UE 3 which requests service(s) on a certain S-NSSAI is not allowed service(s) on that S-NSSAI according to the URSP rule(s) within the UE context for the UE 3 in the AMF 70. If the UE 3 receives such a reject cause ‘S-NSSAI not allowed’, the UE 3 does not allow the rejected Application in the UE 3 to initiate another service on the S-NSSAI on which the service(s) was rejected. Alternatively, if the UE 3 receives such a reject cause ‘S-NSSAI not allowed’, the UE 3 does not allow the rejected Application in the UE 3 to initiate another service on the S-NSSAI on which the service(s) was rejected until the S-NSSAI selection rule(s) (e.g. NSSP) within the UE policy in UE 3 is updated and the updated S-NSSAI selection policy (e.g. NSSP) now allows for that Application to trigger service(s) on that S-NSSAI. The AMF 70 may also include, in the DL NAS Transport message, per Application S-NSSAI back-off timer (e.g. App_Id, S-NSSAI, back-off timer or any other notation for a back-off timer which is only applicable for a specific application on a specific S-NSSAI). In this case, the UE 3 stores the received per Application S-NSSAI back-off timer and the UE 3 does not allow service(s) from the rejected Application on the S-NSSAI for the duration of the back-off timer for that Application on the S-NSSAI. The back-off timer may be referred to as a back-off timer value in this disclosure.
   DNN not allowed or Application on the DNN not allowed (i.e. the Application with App_Id is not allowed service(s) from the DNN) or any other notation for a reject cause in order to indicate to the UE 3 that the Application in the UE 3 which requests service(s) on a certain DNN is not allowed service(s) on that DNN according to the URSP rule(s) within the UE context for the UE 3 in the AMF 70. If the UE 3 receives such a reject cause ‘DNN not allowed’, the UE 3 does not allow the rejected Application in the UE 3 to initiate another service on the DNN on which the service(s) was rejected. Alternatively, if the UE 3 receives such a reject cause ‘DNN not allowed’, the UE 3 does not allow the rejected Application in the UE 3 to initiate another service on the DNN on which the service(s) was rejected until the DNN selector policy within the UE policy (e.g. “DNN selection” in “Route Selection Descriptor” of the URSP rule(s)) in UE 3 is updated and the updated DNN selector policy now allows for that Application to trigger service(s) on that DNN. The AMF 70 may also include, in the DL NAS Transport message, per Application DNN back-off timer (e.g. App_Id, DNN, back-off timer or any other notation for a back-off timer which is only applicable for a specific application on a specific DNN). In this case the UE 3 stores the received per Application DNN back-off timer and the UE 3 does not allow service(s) from the rejected Application on that DNN for the duration of the DNN back-off timer.
   S-NSSAI out of Time windows (i.e. the Application with App_Id is not allowed service(s) on the S-NSSAI at this time) or any other notation for a reject cause in order to indicate to the UE 3 that the Application in the UE 3 which requests service(s) on a certain S-NSSAI is not allowed service(s) on that S-NSSAI at this time (i.e. the service(s) is requested out of the allowed Time windows for service(s) on the S-NSSAI) according to the URSP rule(s) within the UE context for the UE 3 in the AMF 70. If the UE 3 receives such a reject cause ‘S-NSSAI out of allowed Time windows’, the UE 3 does not allow the rejected Application in the UE 3 to initiate another service on the S-NSSAI on which the service(s) was rejected. Alternatively, if the UE 3 receives such a reject cause ‘S-NSSAI out of allowed Time windows’, the UE 3 does not allow the rejected Application in the UE 3 to initiate another service on the S-NSSAI on which the service(s) was rejected until the S-NSSAI selection Time windows rule(s) within the UE policy (e.g. “Time Window” in “Route Selection Descriptor” of the URSP rule(s) or in “Route Selection Descriptor” for the S-NSSAI of the URSP rule(s)) in UE 3 is updated and the updated S-NSSAI selection Time windows policy now allows for that Application to trigger service(s) on that S-NSSAI. The AMF 70 may also include, in the DL NAS Transport message, per Application S-NSSAI back-off timer (e.g. App_Id, S-NSSAI, back-off timer or any other notation for a back-off timer which is only applicable for a specific application on a specific S-NSSAI). In this case the UE 3 stores the received per Application S-NSSAI back-off timer and the UE 3 does not allow service(s) from the rejected Application on the S-NSSAT for the duration of the back-off timer for that Application on the S-NSSAI. The AMF 70 may calculate a value for the S-NSSAI back-off timer so that the S-NSSAI back-off timer for the rejected Application expires within the allowed Time windows for that S-NSSAI.
   DNN out of Time windows (i.e. the Application with App_Id is not allowed service(s) on the DNN at this time) or any other notation for a reject cause in order to indicate to the UE 3 that the Application in the UE 3 which requests service(s) on a certain DNN is not allowed service(s) on that DNN at this time (i.e. the service(s) is requested out of the allowed Time windows for service(s) on the DNN) according to the URSP rule(s) within the UE context for the UE 3 in the AMF 70. If the UE 3 receives such a reject cause ‘DNN out of allowed Time windows’, the UE 3 does not allow the rejected Application in the UE 3 to initiate another service on the DNN on which the service(s) was rejected. Alternatively, if the UE 3 receives such a reject cause ‘DNN out of allowed Time windows’, the UE 3 does not allow the rejected Application in the UE 3 to initiate another service on the DNN on which the service(s) was rejected until the DNN selection Time windows rule(s) within the UE policy (e.g. “Time Window” in “Route Selection Descriptor” of the URSP rule(s) or in “Route Selection Descriptor” for the DNN of the URSP rule(s) in this disclosure) in UE 3 is updated and the updated DNN selection Time windows policy now allows for that Application to trigger service(s) on that DNN. The AMF 70 may also include, in the DL NAS Transport message, per Application DNN back-off timer (e.g. App_Id, DNN, back-off timer or any other notation for a back-off timer which is only applicable for a specific application on a specific DNNI). In this case the UE 3 stores the received per Application DNN back-off timer and the UE 3 does not allow service(s) from the rejected Application on the DNN for the duration of the back-off timer for that Application on the DNN. The AMF 70 may calculate a value for the DNN back-off timer so that the DNN back-off timer for the rejected Application expires within the allowed Time windows for that DNN.
   S-NSSAI out of Location (i.e. the Application with App_Id is not allowed service(s) with the S-NSSAI in this location or area) or any other notation for a reject cause in order to indicate to the UE 3 that the Application in the UE 3 which requests service(s) on a certain S-NSSAI is not allowed service(s) on that S-NSSAI in the current location (i.e. the service(s) is requested out of the allowed Location for service(s) on the S-NSSAI) according to the URSP rule(s) within the UE context for the UE 3 in the AMF 70. If the UE 3 receives such a reject cause ‘S-NSSAI out of Location’, the UE 3 does not allow the rejected Application in the UE 3 to initiate another service on the S-NSSAI on which the service(s) was rejected. Alternatively, if the UE 3 receives such a reject cause ‘S-NSSAI out of Location’, the UE 3 does not allow the rejected Application in the UE 3 to initiate another service on the S-NSSAI on which the service(s) was rejected until the UE 3 reselects another cell or the UE 3 moves to another Tracking Area (TA) or to another Registration Area (RA) or another PLMN or the S-NSSAI selection Location rule(s) within the UE policy (e.g. “Location Criteria” in “Route Selection Descriptor” of the URSP rule(s) or in “Route Selection Descriptor” for the S-NSSAI of the URSP rule(s)) in UE 3 is updated and the updated S-NSSAI selection Location policy now allows for that Application to trigger service(s) on that S-NSSAI. The AMF 70 may also include, in the DL NAS Transport message, per Application S-NSSAI back-off timer (e.g. App_Id_S-NSSAI, back-off timer or any other notation for a back-off timer which is only applicable for a specific application on a specific S-NSSAI). In this case the UE 3 stores the received per Application S-NSSAI back-off timer and the UE 3 does not allow service(s) from the rejected Application on the S-NSSAI for the duration of the back-off timer for that Application on the S-NSSAI unless the UE reselects another cell or moves to another TA or another RA or another PLMN.
   DNN out of Location (i.e. the Application with App_Id is not allowed service(s) on the DNN in this location or area) or any other notation for a reject cause in order to indicate to the UE 3 that the Application in the UE 3 which requests service(s) on a certain DNN is not allowed service(s) on that DNN in the current location or area (i.e. the service(s) is requested out of the allowed Location for service(s) on the DNN) according to the URSP rule(s) within the UE context for the UE 3 in the AMF 70. If the UE 3 receives such a reject cause ‘DNN out of Location’, the UE 3 does not allow the rejected Application in the UE 3 to initiate another service on the DNN on which the service(s) was rejected. Alternatively, if the UE 3 receives such a reject cause ‘DNN out of Location’, the UE 3 does not allow the rejected Application in the UE 3 to initiate another service on the DNN on which the service(s) was rejected until the UE 3 reselects another cell or the UE 3 moves to another Tracking Area (TA) or to another Registration Area (RA) or to another PLMN or the DNN selection Location rule(s) within the UE policy (e.g. “Location Criteria” in “Route Selection Descriptor” of the URSP rule(s) or in “Route Selection Descriptor” for the DNN of the URSP rule(s)) in UE 3 is updated and the updated DNN selection Location policy now allows for that Application to trigger service(s) on that DNN. The AMF 70 may also include, in the DL NAS Transport message, per Application DNN back-off timer (e.g. App_Id, DNN, back-off timer or any other notation for a back-off timer which is only applicable for a specific application on a specific DNN). In this case the UE 3 stores the received per Application DNN back-off timer and the UE 3 does not allow service(s) from the rejected Application on the DNN for the duration of the back-off timer for that Application on the DNN unless the UE reselects another cell or moves to another TA or to another RA or to another PLMN.

The reject cause may be referred to as information indicating that an application identified by the App_Id is rejected.

The reject cause may be referred to as information indicating that an application in the UE 3 is rejected.

For example, in a case where the UE 3 receives the reject cause, the UE 3 may stop using an application which is identified by the App_Id sent in step 7.

For example, in a case where the UE 3 receives the reject cause, the UE 3 may stop using an application.

The reject cause may be referred to as information requesting to stop using an application which is identified by the App Id sent in step 7.

The reject cause may be referred to as information requesting to stop using an application in the UE 3.

For example, the AMF 70 may check whether current time matches “Time Window” in “Route Selection Descriptor” defined in the URSP rule(s). If the AMF 70 determines that the current time does not match the “Time Window” (e.g. if the AMF 70 determines that the current time is not in time period or time window defined by the “Time Window”), the AMF 70 may send the DL NAS Transport message including the reject cause which is set to “S-NSSAI out of Time windows” or “DNN out of Time windows”.

When the AMF 70 checks the “Time Window”, the AMF 70 uses, as the current time, a time data provided by the NTP (Network Time Protocol) as defined in NPL 6.

For example, the AMF 70 may check whether a current UE 3's location matches “Location Criteria” in “Route Selection Descriptor” defined in the URSP rule(s). If the AMF 70 determines that the current UE 3's location does not match the “Location Criteria” (e.g. if the AMF 70 determines that the current UE 3's location does not match the location or the area defined by the “Location Criteria” or the current UE 3's location is not included in the location or the area defined by the “Location Criteria”), the AMF 70 may send the DL NAS Transport message including the reject cause which is set to “S-NSSAI out of Location” or “DNN out of Location”.

When the AMF 70 checks a location of the UE 3 (e.g. the UE 3's location), the AMF 70 uses a User Location Information in an INITIAL UE message from a RAN 5 when the UL NAS Transport message is conveyed from the RAN 5 to the AMF 70 according to NPL 7.

For example, the AMF 70 may check whether the S-NSSAI received in step 7 matches S-NSSAI(s). If the AMF 70 determines that the S-NSSAI received in step 7 does not match S-NSSAI(s) in the “Network Slice Selection”, the AMF 70 may send the DL NAS Transport message including the reject cause which is set to “S-NSSAI not allowed” or “Application on the S-NSSAI not allowed”.

For example, the AMF 70 may check whether the DNN received in step 7 matches DNN in the URSP rule(s) (e.g. “DNN Selection” in “Route Selection Descriptor” defined in the URSP rule(s)). If the AMF 70 determines that the DNN received in step 7 does not match DNN in the URSP rule(s), the AMF 70 may send the DL NAS Transport message including the reject cause which is set to “DNN not allowed” or “Application on the DNN not allowed”.

The AMF 70 may check whether at least one of the App_Id, DNN, S-NSSAI, the current time and the current UE 3's location matches corresponding parameters in the URSP rule(s) in the manner as mentioned above. If the AMF 70 determines that the at least one of the App_Id, DNN, S-NSSAI, the current time and the current UE 3's location do not match the corresponding parameters in the URSP rule(s), the AMF 70 may send the DL NAS Transport message including the reject cause as mentioned above.

According to the First example of the First Aspect, for example, the 5GC (e.g. the AMF) can be aware whether or when the UE enforces a URSP rule(s). In addition, according to the First example of the First Aspect, for example, it can provide actions that the 5GS (e.g. the AMF) can take after 5GC is aware whether the UE enforces a URSP rule(s). Further, according to the First example of the First Aspect, for example, it can provide a solution which can prevent unauthorized application(s) in the UE.

For example, a first apparatus corresponding to the AMF 70 receives, from a second apparatus corresponding to the PCF 73, policy information for a communication terminal. The first apparatus receives, from the communication terminal corresponding to the UE 3, information for an application for the communication terminal. The first apparatus checks, whether the information for an application for the communication terminal is consistent with the policy information for a communication terminal. The first apparatus sends, to the communication terminal, information related to rejection in a case where the information for an application for the communication terminal is not consistent with the policy information for a communication terminal.

### Variant 1 of First Example of the First Aspect

In step 2, the PCF 73 may send the UE policy to the AMF 70 by an Npcf_UEPolicyControl Create Response message. The UE policy may be the same as the UE policy that the PCF 73 provides to the UE 3 in the UE Policy container during the UE Configuration Update procedure for transparent UE Policy delivery procedure as defined in section 4.2.4.3 in NPL 4.

### Variant 2 of First Example of the First Aspect

In step 7, the UL NAS Transport message can be replaced with a Service Request message. In this case, the UL NAS Transport message in step 7 is replaced with the Service Request message.

In addition, the DL NAS Transport message in step 9 is replaced with a Service Reject message.

The Service Request message may include same information as the UL NAS Transport message.

The Service Reject message may include same information as the DL NAS Transport message.

### Variant 3 of First Example of the First Aspect

In step 4, instead of including the whole UE Policy in the message to the AMF 70, the PCF 73 may include in the message to the AMF 70 only the UE Policy for UE 3 that are relevant to the PDU Session establishment parameters provided by the UE 3 to the AMF 70 in step 7.

So, the PCF 73 may include in the message to the AMF 70 the S-NSSAI selection policy (e.g. NSSP) for the UE 3, the DNN selection policy (e.g. “DNN Selection” in “Route Selection Descriptor”) for the UE 3, the Time windows parameter for UE 3 which defines time window that service(s) on the S-NSSAI or DNN is allowed (e.g. “Time Window” in “Route Selection Descriptor”) and a Location parameter for UE 3 which defines the location in which service(s) or access on S-NSSAI or DNN is allowed (e.g. “Location Criteria” in “Route Selection Descriptor”). The DNN selection policy may be referred to as DNN selection rule(s). The DNN selection policy may be referred to as the DNN selection rule(s). The Time windows parameter may be referred to as allowed Time Windows parameter. The Location parameter may be referred to as allowed Location. The location parameter may be presented as a Cell Identity or a list of Cell Identities or Tracking Area (TA) Identity or list of TA Identities or Registration Area Identity. The AMF 70 stores or updates these parameters provided by the PCF 73 in the UE Context within the AMF 70. At step 8, the AMF 70 validates whether at least one of the S-NSSAI and DNN provided by the UE 3 for the Application with App_Id parameter in the NAS message to the AMF 70 in step 7 matches at least one of the S-NSSAI selection rule(s), the DNN selection rule(s), the allowed Time Windows and the allowed Location for the Application with App_ID from the UE context in the AMF 70. If at least one of these rules is not matched, the AMF 70 rejects the NAS message from UE 3 with a reject cause as per the description in step 9 in FIG. 1.

For example, the PCF 73 may obtain information regarding the PDU session that the UE 3 may establish from other network nodes. For example, the PCF 73 may store information regarding the PDU session that the UE 3 may establish in advance. The information regarding the PDU session that the UE 3 may establish may include the S-NSSAI selection policy (NSSP) for the UE 3, the DNN selection policy for the UE 3, the Time windows parameter for UE 3 which defines time window that service(s) on the S-NSSAT or DNN is allowed and the Location parameter for UE 3 which defines the location in which service(s) or access on S-NSSAI or DNN is allowed. The PCF 73 may determine contents of the message in step 4 on the basis of the information regarding the PDU session that the UE 3 may establish.

### Second Example of the First Aspect

A Second example of the First Aspect discloses a method where a PCF 73 sends the UE policy to an SMF 71 via an AMF 70 when a PDU session establishment is requested by a UE 3. Then the SMF 71 checks a requested PDU session from the UE 3 whether the request from the UE 3 is consistent with the UE policy.

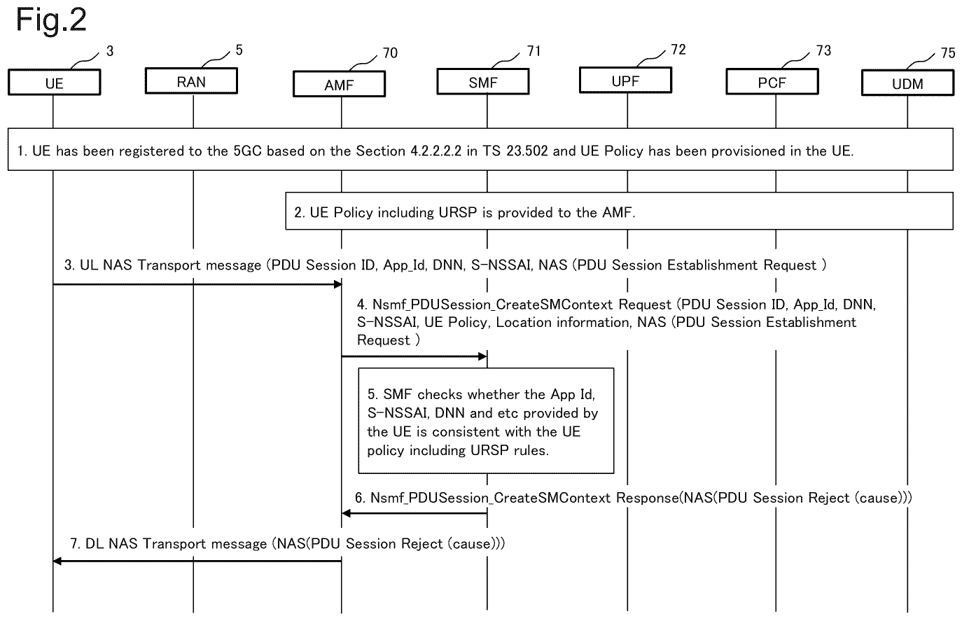

The detailed processes of the Second example of the First Aspect are described below, with reference to FIG. 2.
Step 1 is the same as the steps 1 to 6 in the First example of the First Aspect.
Step 2: The UE Policy including URSP is provided to the AMF 70 by the PCF 73 as specified in steps 4 and 5 of the First example of the First Aspect. If the AMF 70 already receives the UE policy from the PCF 73 in step 1, the step 2 may be skipped.
Step 3: At some point, the UE 3 sends a UL NAS Transport message to the AMF 70 including PDU Session ID, App_Id, DNN, S-NSSAI and NAS container that includes PDU Session Establishment Request to establish a PDU session or Service Request message or any other NAS message with the purpose of establishing a new PDU Session or with the purpose to re-use an already established PDU Session or modify the already established PDU Session.
Step 4: Upon reception of the UL NAS Transport message from the UE 3, the AMF 70 sends an Nsmf_PDUSession_CreateSMContext Request message to the SMF 71 including the PDU Session ID, the App_Id, the DNN, the S-NSSAI, the UE Policy and SM NAS container that contains the PDU Session Establishment Request message. The Nsmf_PDUSession_CreateSMContext Request message may include Location information. The UE Policy parameter (or the UE Policy) is populated by the AMF 70 from the UE context of the UE 3. The UE Policy may be one received from the PCF 73 in step 1 or step 2. The Location information is populated by the AMF 70 from the received User Location Information in an INITIAL UE message from a RAN 5. The Location information may indicate a current location of the UE 3. The AMF 70 may use, as the Location information, a User Location Information in an INITIAL UE MESSAGE from a RAN 5 when the UL NAS Transport message is conveyed from the RAN 5 to the AMF 70 according to NPL 7.
Step 5: Upon reception of the Nsmf_PDUSession_CreateSMContext Request message from the AMF 70, the SMF 71 checks whether at least one of the App_Id, S-NSSAI, DNN and other information etc provided by the AMF 70 is consistent with the UE policy that is received from the AMF 70 (for example, the SMF 71 checks whether the received application identity (i.e., the App Id) matches any route descriptor rule(s) defined in the NSSP corresponding to the application identity or whether the received App_Id matches any application identities in the URSP rule(s) or whether the received App_Id matches any application identities in “Application descriptors” of the URSP rule(s)).

When the SMF 71 checks whether at least one of the App_Id etc. provided by the AMF 70 is consistent with the UE policy, the SMF 71 may check the UE policy or the URSP rule(s) corresponding to the PDU Session ID received in step 4.
Step 6: If the SMF 71 finds that at least one of the received parameter(s) in the Nsmf_PDUSession_CreateSMContext Request message is not consistent with the UE policy (for example, if the received application identity (i.e., the received App_Id) does not match any route descriptor rule(s) defined in the NSSP corresponding to the application identity or if the received App_Id does not match any application identities in the URSP rule(s) or if the received App_Id does not match any application identities in “Application descriptors” of the URSP rule(s)), then the SMF 71 sends an Nsmf_PDUSession_CreateSMContext Response message to the AMF 70 including a cause parameter. Otherwise (e.g. if the SMF 71 finds that at least one of the received parameter(s) in the Nsmf_PDUSession_CreateSMContext Request message is consistent with the UE policy), the SMF 71 continues with the PDU Session establishment procedure as per TS23.502, clause 4.3.2.2.1. If the PDU Session Establishment Request is rejected by the SMF 71 or if the SMF 71 finds that at least one of the received parameter(s) in the Nsmf_PDUSession_CreateSMContext Request message is not consistent with the UE policy, the cause parameter included in the Nsmf_PDUSession_CreateSMContext Response message to the AMF 70 may have one value or multiple values from the cause listed below. They may be all SM causes. The cause parameter may be correspond to the App_Id received from the UE 3 in step 3.
   S-NSSAI not allowed or Application on the S-NSSAI not allowed (i.e. the Application with App_Id is not allowed service(s) on the S-NSSAI) or any other notation for a reject cause in order to indicate to the UE 3 that the Application in the UE 3 which requests service(s) on a certain S-NSSAI is not allowed service(s) on that S-NSSAI according to the URSP rule(s) within the SMF 71. If the UE 3 receives such a reject cause ‘S-NSSAI not allowed’, the UE 3 does not allow the rejected Application in the UE 3 to initiate another service on the S-NSSAI on which the service(s) was rejected. Alternatively, if the UE 3 receives such a reject cause ‘S-NSSAI not allowed’, the UE 3 does not allow the rejected Application in the UE 3 to initiate another service on the S-NSSAI on which the service(s) was rejected until the S-NSSAI selection rule(s) (e.g. NSSP) within the UE policy in UE 3 is updated and the updated S-NSSAI selection policy (e.g. NSSP) now allows for that Application to trigger service(s) on that S-NSSAI. The SMF 71 may also include, in the Nsmf_PDUSession_CreateSMContext Response message, per Application S-NSSAI back-off timer (e.g. App_Id, S-NSSAI, back-off timer or any other notation for a back-off timer which is only applicable for a specific application on a specific S-NSSAI). In this case the UE 3 stores the received per Application S-NSSAI back-off timer and the UE 3 does not allow service(s) from the rejected Application on the S-NSSAI for the duration of the back-off timer for that Application on the S-NSSAI.
   DNN not allowed or Application on the DNN not allowed (i.e. the Application with App_Id is not allowed service(s) from the DNN) or any other notation for a reject cause in order to indicate to the UE 3 that the Application in the UE 3 which requests service(s) on a certain DNN is not allowed service(s) on that DNN according to the URSP rule(s) within the SMF 71. If the UE 3 receives such a reject cause ‘DNN not allowed’, the UE 3 does not allow the rejected Application in the UE 3 to initiate another service on the DNN on which the service(s) was rejected. Alternatively, if the UE 3 receives such a reject cause ‘DNN not allowed’, the UE 3 does not allow the rejected Application in the UE 3 to initiate another service on the DNN on which the service(s) was rejected until the DNN selector policy within the UE policy (e.g. “DNN selection” in “Route Selection Descriptor” of the URSP rule(s)) in UE 3 is updated and the updated DNN selector policy now allows for that Application to trigger service(s) on that DNN. The SMF 71 may also include, in the Nsmf_PDUSession_CreateSMContext Response message, per Application DNN back-off timer (e.g. App_Id, DNN, back-off timer or any other notation for a back-off timer which is only applicable for a specific application on a specific DNN). In this case the UE 3 stores the received per Application DNN back-off timer and the UE 3 does not allow service(s) from the rejected Application on that DNN for the duration of the DNN back-off timer.
   S-NSSAI out of Time windows (i.e. the Application with App_Id is not allowed service(s) on the S-NSSAI at this time) or any other notation for a reject cause in order to indicate to the UE 3 that the Application in the UE 3 which requests service(s) on a certain S-NSSAI is not allowed service(s) on that S-NSSAI at this time (i.e. the service(s) is requested out of the allowed Time windows for service(s) on the S-NSSAI) according to the URSP rule(s) within the SMF 71. If the UE 3 receives such a reject cause ‘S-NSSAI out of allowed Time windows’, the UE 3 does not allow the rejected Application in the UE 3 to initiate another service on the S-NSSAI on which the service(s) was rejected. Alternatively, if the UE 3 receives such a reject cause ‘S-NSSAI out of allowed Time windows’, the UE 3 does not allow the rejected Application in the UE 3 to initiate another service on the S-NSSAI on which the service(s) was rejected until the S-NSSAI selection Time windows rule(s) within the UE policy (e.g. “Time Window” in “Route Selection Descriptor” of the URSP rule(s) or in “Route Selection Descriptor” for the S-NSSAI of the URSP rule(s)) in UE 3 is updated and the updated S-NSSAI selection Time windows policy now allows for that Application to trigger service(s) on that S-NSSAI. The SMF 71 may also include, in the Nsmf_PDUSession_CreateSMContext Response message, per Application S-NSSAI back-off timer (e.g. App_Id, DNN, back-off timer or any other notation for a back-off timer which is only applicable for a specific application on a specific S-NSSAI). In this case the UE 3 stores the received per Application S-NSSAI back-off timer and the UE 3 does not allow service(s) from the rejected Application on the S-NSSAI for the duration of the back-off timer for that Application on the S-NSSAI. The SMF 71 may calculate a value for the S-NSSAI back-off timer so that the S-NSSAI back-off timer for the rejected Application expires within the allowed Time windows for that S-NSSAI.
   DNN out of Time windows (i.e. the Application with App_Id is not allowed service(s) on the DNN at this time) or any other notation for a reject cause in order to indicate to the UE 3 that the Application in the UE 3 which requests service(s) on a certain DNN is not allowed service(s) on that DNN at this time (i.e. the service(s) is requested out of the allowed Time windows for service(s) on the DNN) according to the URSP rule(s) within the SMF 71. If the UE 3 receives such a reject cause ‘DNN out of allowed Time windows’, the UE 3 does not allow the rejected Application in the UE 3 to initiate another service on the DNN on which the service(s) was rejected. Alternatively, if the UE 3 receives such a reject cause ‘DNN out of allowed Time windows’, the UE 3 does not allow the rejected Application in the UE 3 to initiate another service on the DNN on which the service(s) was rejected until the DNN selection Time windows rule(s) within the UE policy (e.g. “Time Window” in “Route Selection Descriptor” of the URSP rule(s) or in “Route Selection Descriptor” for the DNN of the URSP rule(s) in this disclosure) in UE 3 is updated and the updated DNN selection Time windows policy now allows for that Application to trigger service(s) on that DNN. The SMF 71 may also include, in the Nsmf_PDUSession_CreateSMContext Response message, per Application DNN back-off timer (e.g. App_Id, DNN, back-off timer or any other notation for a back-off timer which is only applicable for a specific application on a specific DNNI). In this case the UE 3 stores the received per Application DNN back-off timer and the UE 3 does not allow service(s) from the rejected Application on the DNN for the duration of the back-off timer for that Application on the DNN. The SMF 71 may calculate a value for the DNN back-off timer so that the DNN back-off timer for the rejected Application expires within the allowed Time windows for that DNN.
   S-NSSAI out of Location (i.e. the Application with App_Id is not allowed service(s) with the S-NSSAI in this location) or any other notation for a reject cause in order to indicate to the UE 3 that the Application in the UE 3 which requests service(s) on a certain S-NSSAI is not allowed service(s) on that S-NSSAI in the current location (i.e. the service(s) is requested out of the allowed Location for service(s) on the S-NSSAI) according to the URSP rule(s) within SMF 71. If the UE 3 receives such a reject cause ‘S-NSSAI out of Location’, the UE 3 does not allow the rejected Application in the UE 3 to initiate another service on the S-NSSAI on which the service(s) was rejected. Alternatively, if the UE 3 receives such a reject cause ‘S-NSSAI out of Location’, the UE 3 does not allow the rejected Application in the UE 3 to initiate another service on the S-NSSAI on which the service(s) was rejected until the UE 3 reselects another cell or the UE 3 moves to another Tracking Area (TA) or to another Registration Area (RA) or another PLMN or the S-NSSAI selection Location rule(s) within the UE policy (e.g. “Location Criteria” in “Route Selection Descriptor” of the URSP rule(s) or in “Route Selection Descriptor” for the S-NSSAI of the URSP rule(s)) in UE 3 is updated and the updated S-NSSAI selection Location policy now allows for that Application to trigger service(s) on that S-NSSAI. The SMF 71 may also include, in the Nsmf_PDUSession_CreateSMContext Response message, per Application S-NSSAT back-off timer (e.g. App Id, DNN, back-off timer or any other notation for a back-off timer which is only applicable for a specific application on a specific S-NSSAI). In this case the UE 3 stores the received per Application S-NSSAI back-off timer and the UE 3 does not allow service(s) from the rejected Application on the S-NSSAI for the duration of the back-off timer for that Application on the S-NSSAI) unless the UE reselects another cell or moves to another TA or another RA or another PLMN.
   DNN out of Location (i.e. the Application with App_Id is not allowed service(s) on the DNN in this location) or any other notation for a reject cause in order to indicate to the UE 3 that the Application in the UE 3 which requests service(s) on a certain DNN is not allowed service(s) on that DNN in the current location (i.e. the service(s) is requested out of the allowed Location for service(s) on the DNN) according to the URSP rule(s) within the SMF 71. If the UE 3 receives such a reject cause ‘DNN out of Location’, the UE 3 does not allow the rejected Application in the UE 3 to initiate another service on the DNN on which the service(s) was rejected. Alternatively, if the UE 3 receives such a reject cause ‘DNN out of Location’, the UE 3 does not allow the rejected Application in the UE 3 to initiate another service on the DNN on which the service(s) was rejected until the UE 3 reselects another cell or the UE 3 moves to another Tracking Area (TA) or to another Registration Area (RA) or to another PLMN or the DNN selection Location rule(s) within the UE policy (e.g. “Location Criteria” in “Route Selection Descriptor” of the URSP rule(s) or in “Route Selection Descriptor” for the DNN of the URSP rule(s)) in UE 3 is updated and the updated DNN selection Location policy now allows for that Application to trigger service(s) on that DNN. The SMF 71 may also include, in the Nsmf_PDUSession_CreateSMContext Response message, per Application DNN back-off timer (e.g. App_Id, DNN, back-off timer or any other notation for a back-off timer which is only applicable for a specific application on a specific DNN). In this case the UE 3 stores the received per Application DNN back-off timer and the UE 3 does not allow service(s) from the rejected Application on the DNN for the duration of the back-off timer for that Application on the DNN) unless the UE reselects another cell or moves to another TA or to another RA or to another PLMN.

For example, the SMF 71 may check whether current time matches “Time Window” in “Route Selection Descriptor” defined in the URSP rule(s). If the SMF 71 determines that the current time does not match the “Time Window” (e.g. if the SMF 71 determines that the current time is not in time period or time window defined by the “Time Window”), the SMF 71 may send the DL NAS Transport message including the reject cause which is set to “S-NSSAI out of Time windows” or “DNN out of Time windows”.

When the SMF 71 checks the “Time Windows”, the SMF 71 uses, as the current time, a time data provided by the NTP (Network Time Protocol) as defined in NPL 6.

For example, the SMF 71 may check whether a current UE 3's location matches “Location Criteria” in “Route Selection Descriptor” defined in the URSP rule(s). If the SMF 71 determines that the current UE 3's location does not match the “Location Criteria” (e.g. if the SMF 71 determines that the current UE 3's location does not match the location or the area defined by the “Location Criteria” or the current UE 3's location is not included in the location or the area defined by the “Location Criteria”), the SMF 71 may send the DL NAS Transport message including the reject cause which is set to “S-NSSAI out of Location” or “DNN out of Location”.

When the SMF 71 checks a location of the UE 3 (e.g. the US 3's location), the SMF 71 uses a User Location Information received from the AMF 70 in the Nsmf_PDUSession_CreateSMContext Request message.
Step 7: Upon reception of the Nsmf_PDUSession_CreateSMContext Response message from the SMF 71, the AMF 70 sends a DL NAS Transport message to the UE 3 including the SM NAS container that contains the PDU Session reject message with the cause parameter. The UE 3 may perform process(es) based on the cause parameter as mentioned in step 6 in a case where the UE 3 receives the cause parameter.

The SMF 71 may check whether at least one of the App_Id, DNN, S-NSSAI, the current time and the current UE 3's location matches corresponding parameters in the URSP rule(s) in the same manner as the AMF 70 in the First example of the First Aspect. If the SMF 71 determines that the at least one of the App_Id, DNN, S-NSSAI, the current time and the current UE 3's location do not match the corresponding parameters in the URSP rule(s), the SMF 71 may send the reject cause via the AMF 70 as mentioned above.

For example, a third apparatus corresponding to the SMF 71 stores policy information for a communication terminal from a second apparatus. For example, the communication terminal corresponding to the UE 3. For example, the second apparatus corresponding to the PCF 73. The third apparatus receives, from the communication terminal, information for an application for the communication terminal. The third apparatus checks, whether the information for an application for the communication terminal is consistent with the policy information for the communication terminal. The third apparatus sends, to a first apparatus corresponding to the AMF 70, information related to rejection in a case where the information for an application for the communication terminal is not consistent with the policy information for a communication terminal.

According to the Second example of the First Aspect, for example, the 5GC (e.g. the SMF) can be aware whether or when the UE enforces a URSP rule(s). In addition, according to the Second example of the First Aspect, for example, it can provide actions that the 5GS (e.g. the SMF) can take after 5GC is aware whether the UE enforces a URSP rule(s). Further, according to the Second example of the First Aspect, for example, it can provide a solution which can prevent unauthorized application(s) in the UE.

### Variant 1 of Second Example of the First Aspect

When the SMF 71 receives the Nsmf_PDUSession_CreateSMContext Request message from the AMF 70 in step 4, the SMF 71 may obtain the UE policy information from the PCF 73 via an Npcf_UEPolicyControl Service provided by the PCF 73. In this case, the following steps take place between the SMF 71 and the PCF 73.
The SMF 71 sends an Npcf_UEPolicyControl_Create message to the PCF 73 including User ID. The User ID may be an identity of the UE 3. The User ID may be a SUPI. The User ID may be a SUPI of the UE 3.
The PCF 73 finds the UE policy rule(s) based on the received User ID (e.g. the PCF 73 finds the UE policy for the UE 3) and sends an Npcf_UEPolicyControl_UpdateNotify message to the SMF 71 including the UE policy. The UE policy may be expressed by the UE Policy Association ID.

If the Nsmf_PDUSession_CreateSMContext Request message does not include the UE policy, the SMF 71 may send the Npcf_UEPolicyControl_Create message to the PCF 73.

Regardless that the Nsmf_PDUSession_CreateSMContext Request message includes the UE policy, the SMF 71 may send the Npcf_UEPolicyControl_Create message to the PCF 73.

### Variant 2 of Second Example of the First Aspect

In step 3, the UL NAS Transport message can be replaced with a Service Request message. In this case, the UL NAS Transport message in step 3 is replaced with the Service Request message.

In addition, the DL NAS Transport message in step 7 is replaced with a Service Reject message.

The Service Request message may include same information as the UL NAS Transport message.

The Service Reject message may include same information as the DL NAS Transport message.

### Third Example of the First Aspect

A Third example of the First Aspect discloses a method where a PCF 73 sends the UE policy to a UPF 72 via an AMF 70 and a SMF 71 when a PDU session establishment is requested by a UE 3. Then the UPF 72 checks an uplink user data from the UE 3 whether the user data from the UE 3 is consistent with the UE policy.

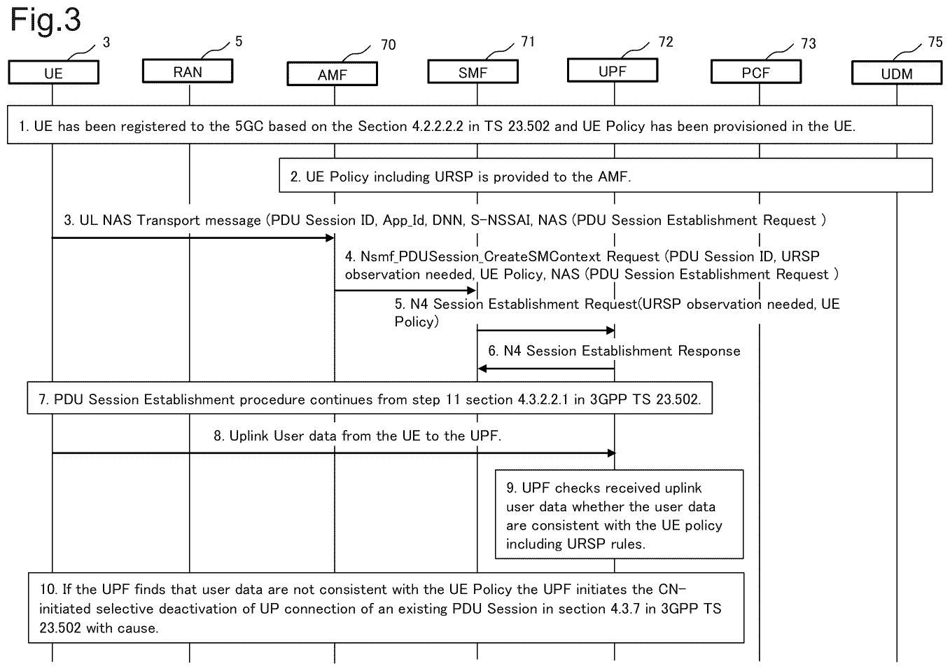

The detailed processes of the Third example of the First Aspect are described below, with reference to FIG. 3.
Step 1 is the same as the sequence of steps 1 to 6 in the First example of the First Aspect.
Step 2: The UE Policy including URSP is provided to the AMF 70 by the PCF 73 as specified in steps 4 and 5 of the First example of the First Aspect. If the AMF 70 already receives the UE policy from the PCF 73 in step 1, the step 2 may be skipped.
Step 3: At some point, the UE 3 sends a UL NAS Transport message to the AMF 70 including PDU Session ID, App_Id, DNN, S-NSSAI and NAS container that includes PDU Session Establishment Request to establish a PDU session or Service Request message or any other NAS message with the purpose of establishing a new PDU Session or with the purpose to re-use an already established PDU Session or modify the already established PDU Session.
Step 4: Upon reception of the UL NAS Transport message from the UE 3, the AMF 70 sends an Nsmf_PDUSession_CreateSMContext Request message to the SMF 71 including the PDU Session ID, the App_Id, the DNN, the S-NSSAI, “URSP observation needed” parameter and the UE Policy and SM NAS container that contains the PDU Session Establishment Request message. The UE Policy parameter is populated by the AMF 70 from the UE context of the UE 3. The UE Policy may be one received from the PCF 73 in step 1 or step 2. The “URSP observation needed” parameter is populated or created by the AMF 70 to indicate the SMF 71 that the user data checking at the UPF 72 is requested. The “URSP observation needed” parameter may be referred to as information indicating that checking of data of the UE 3 or data related to UE 3 is needed.
Step 5: Upon reception of the Nsmf_PDUSession_CreateSMContext Request message from the AMF 70, the SMF 71 sends, to the UPF 72, a N4 Session Establishment Request message including the “URSP observation needed” parameter and the UE Policy. The “URSP observation needed” parameter and the UE Policy may be populated by copying from the parameters that are received in the Nsmf_PDUSession_CreateSMContext Request message from the AMF 70. The “URSP observation needed” parameter and the UE Policy may be one that are received in the Nsmf_PDUSession_CreateSMContext Request message from the AMF 70.
Step 6: The UPF 72 sends an N4 Session Establishment Response message to the SMF 71. In a case where the UPF 72 receives the N4 Session Establishment Request message from the SMF 71, the UPF 72 may send the N4 Session Establishment Response message.
Step 7: The PDU Session Establishment procedure continues from step 11 section 4.3.2.2.1 in NPL 4.
Step 8: The UPF 72 receives uplink user data from the UE 3 via the RAN 5. The uplink user data may include the App_ID.
Step 9: Upon reception of the uplink user data from the UE 3 via RAN 5, the UPF 72 checks whether the received uplink user data is consistent with the UE policy that is received from the PCF 73 via the AMF 70 and SMF 71 (for example, if the received application identity (i.e., the App_Id) does not match any route descriptor rule(s) defined in the NSSP corresponding to the application identity or whether the received App_Id matches any application identities in the URSP rule(s) or whether the received App_Id matches any application identities in “Application descriptors” of the URSP rule(s)).
Step 10: If the UPF 72 finds that the received uplink user data is not consistent with the UE policy (for example, if the received application identity (i.e., the App_Id) does not match any route descriptor rule(s) defined in the NSSP corresponding to the application identity or if the received App_Id does not match any application identities in the URSP rule(s) or if the received App_Id does not match any application identities in “Application descriptors” of the URSP rule(s)), then the UPF 72 requests the SMF 71 to initiate the CN-initiated selective deactivation of UP connection of an existing PDU Session procedure as described in section 4.3.7 in NPL 4. The UPF 72 may indicate a cause value (or a cause parameter) to the SMF 71 asking to set it as the SM cause value. For example, the UPF 72 may send the cause value to the SMF 71. In a case where the SMF 71 receives the cause value, the SMF 71 may send the cause value to the UE 3. For example, the SMF 71 may send, to the UE 3, the cause value to the UE 3 by using a DL NAS Transport message. In a case where the UE 3 receives the cause value, the UE 3 may stop sending the uplink user data to the UPF 72.

The requesting the SMF 71 to initiate the CN-initiated selective deactivation of UP connection of an existing PDU Session procedure may be referred to as performing deactivation of communication related to the data of the UE 3.

For example, if the UPF 72 finds that the received uplink user data is consistent with the UE policy, the UPF 72 may process the received uplink user data for communication with the UE 3. For example, if the UPF 72 finds that the received uplink user data is consistent with the UE policy, user data exchange (e.g. exchange of the uplink user data) may not be interrupted or processed appropriately.

The cause parameter may have one value or multiple values from the cause listed below. They may be all SM causes.
IP descriptors do not match.
Destination IP address is out of range as defined in the IP descriptors.
IPv6 prefix is out of range as defined in the IP descriptors.
Port number is out of range as defined in the IP descriptors.
Protocol ID is out of range as defined in the IP descriptors.
FQDN does not match with the ones defined in the Domain descriptors.
Out of Time windows

For example, the UPF 72 may check whether current time (e.g. the current time when the UPF 72 receives the uplink user data or the checking is performed. Information indicating the current time may be included in the uplink user data) matches “Time Window” in “Route Selection Descriptor” defined in the URSP rule(s). If the UPF 72 determines that the current time does not match the “Time Window” (e.g. if the UPF 72 determines that the current time is not in time period or time window defined by the “Time Window”), the UPF 72 may request the SMF 71 to initiate the CN-initiated selective deactivation of UP connection of an existing PDU Session procedure. In addition, the UPF 72 may send the cause parameter which is set to “Out of Time windows” to the SMF 71 and the SMF 71 may send the cause parameter to the UE 3.

When the UPF 72 checks the “Time Windows”, the UPF 72 may use, as the current time, a time data provided by the NTP (Network Time Protocol) as defined in NPL 6.

For example, the uplink user data may include at least one of information regarding IP address (e.g. destination IP address, IPv6 prefix, port number, protocol ID), and information regarding domain name (e.g. FQDN(s)).

For example, the UPF 72 may check whether the at least one of the information regarding IP address and the information regarding domain name matches the corresponding information in the URSP rule(s). For example, the UPF 72 may check at least one of the following:
whether the destination IP address of the uplink user data matches “IP descriptors” in the URSP rule(s);
whether the IPv6 prefix of the uplink user data matches “IP descriptors” in the URSP rule(s) or whether the IPv6 prefix of the uplink user data is in range defined by “IP descriptors” in the URSP rule(s);
whether the port number of the uplink user data matches “IP descriptors” in the URSP rule(s) or whether the port number of the Uplink user data is in range defined by “IP descriptors” in the URSP rule(s);
whether the Protocol ID of the uplink user data matches “IP descriptors” in the URSP rule(s) or whether the Protocol ID of the uplink user data is in range defined by “IP descriptors” in the URSP rule(s); and
whether the FQDN of the uplink user data matches FQDN(s) defined by “Domain descriptors” in the URSP rule(s).

In a case where the UPF 72 determines that the destination IP address of the Uplink user data does not match “IP descriptors” in the URSP rule(s), the UPF 72 may request the SMF 71 to initiate the CN-initiated selective deactivation of UP connection of an existing PDU Session procedure. In addition, the UPF 72 may send the cause parameter which is set to “IP descriptors does not match” or “Destination IP address is out of range as defined in the IP descriptors” to the SMF 71, and the SMF 71 may send the cause parameter to the UE 3.

In a case where the UPF 72 determines that the IPv6 prefix of the Uplink user data does not match “IP descriptors” in the URSP rule(s) or that the IPv6 prefix of the Uplink user data is out of range defined by “IP descriptors” in the URSP rule(s), the UPF 72 may request the SMF 71 to initiate the CN-initiated selective deactivation of UP connection of an existing PDU Session procedure. In addition, the UPF 72 may send the cause parameter which is set to “IP descriptors does not match” or “IPv6 prefix is out of range as defined in the IP descriptors” to the SMF 71, and the SMF 71 may send the cause parameter to the UE 3.

In a case where the UPF 72 determines that the port number of the Uplink user data does not match “IP descriptors” in the URSP rule(s) or that the port number of the Uplink user data is out of range defined by “IP descriptors” in the URSP rule(s), the UPF 72 may request the SMF 71 to initiate the CN-initiated selective deactivation of UP connection of an existing PDU Session procedure. In addition, the UPF 72 may send the cause parameter which is set to “IP descriptors does not match” or “Port number is out of range as defined in the IP descriptors” to the SMF 71, and the SMF 71 may send the cause parameter to the UE 3.

In a case where the UPF 72 determines that the Protocol ID of the Uplink user data does not match “IP descriptors” in the URSP rule(s) or that the Protocol ID of the Uplink user data is out of range defined by “IP descriptors” in the URSP rule(s), the UPF 72 may request the SMF 71 to initiate the CN-initiated selective deactivation of UP connection of an existing PDU Session procedure. In addition, the UPF 72 may send the cause parameter which is set to “IP descriptors does not match” or “Protocol ID is out of range as defined in the IP descriptors” to the SMF 71, and the SMF 71 may send the cause parameter to the UE 3.

In a case where the UPF 72 determines that the FQDN of the Uplink user data does not match FQDN(s) defined by “Domain descriptors” in the URSP rule(s), the UPF 72 may request the SMF 71 to initiate the CN-initiated selective deactivation of UP connection of an existing PDU Session procedure. In addition, the UPF 72 may send the cause parameter which is set to “FQDN does not match with the ones defined in the Domain descriptors” to the SMF 71, and the SMF 71 may send the cause parameter to the UE 3.

The UPF 72 may check whether at least one of the App_Id, the current time, the information regarding IP address and the information regarding domain name matches corresponding parameters in the URSP rule(s) in the manner mentioned above. If the UPF 72 determines that the at least one of the App_Id, the current time, the information regarding IP address and the information regarding domain name do not match the corresponding parameters in the URSP rule(s), the UPF 72 may request the SMF 71 to initiate the CN-initiated selective deactivation of UP connection of an existing PDU Session procedure and send the cause parameter as mentioned above.

According to the Third example of the First Aspect, for example, the 5GC (e.g. the UPF) can be aware whether or when the UE enforces a URSP rule(s). In addition, according to the Third example of the First Aspect, for example, it can provide actions that the 5GS (e.g. the UPF) can take after 5GC is aware whether the UE enforces a URSP rule(s). Further, according to the Third example of the First Aspect, for example, it can provide a solution which can prevent from unauthorized application(s) in the UE routing traffic via the existing PDU sessions.

For example, a fourth apparatus corresponding to the UPF 72 stores policy information for a communication terminal from a second apparatus. For example, the communication terminal corresponding to the UE3. For example, the second apparatus corresponding to the PCF 73. The fourth apparatus receives, from a third apparatus, information for an application for the communication terminal. For example, the third apparatus corresponding to the SMF 71. The fourth apparatus receives, from the third apparatus, information indicates checking data related to a communication terminal is needed. The fourth apparatus checks whether the information for an application for the communication terminal is consistent with the policy information for a communication terminal based on the information indicates checking data related to the communication terminal is needed. The fourth apparatus sends information related to rejection in a case the information for an application for the communication terminal is not consistent with the policy information for a communication terminal.

### Variant 1 of Third Example of the First Aspect

In step 8, the UPF 72 may check the user location whether UE 3 is in an allowed location or not as defined in the URSP rule(s). To make location checking possible at the UPF 72, the RAN 5 populates the Cell ID where the UE 3 is connected in the RAN Container or the NR RAN Container in the GTP-U header whenever the RAN 5 sends the GTP-U data to the UPF 72. The UPF 72 checks the cell ID in the GTP-U whether the received Cell ID is in the range of allowed location or allowed area as defined in the URSP rule(s).

If the UPF 72 finds that the received Cell ID is out of range defined in the URSP rule(s) (e.g. if the UPF 72 determines that the received Cell ID does not match a Cell ID indicated by the URSP rule(s), or if the UPF 72 determines that location indicated by the received Cell ID does not match location or area indicated by the URSP rule(s)), then the UPF 72 requests the SMF 71 to initiate the CN-initiated selective deactivation of UP connection of an existing PDU Session procedure as described in section 4.3.7 in NPL 4. The UPF 72 may indicate a cause value to the SMF 71 asking to set it as the SM cause value

The cause parameter may be indicated below. This may be an SM cause.
Out of Location

The UPF 72 may convert location indicated by the URSP rule(s) to a Cell ID. The UPF 72 may convert the received Cell ID to location information which can be used for the location checking.

The UPF 72 may perform the converting based on local configuration or operator's policy stored in the UPF 72. The UPF 72 may receive information for the converting from another network node. The UPF 72 may store information for the converting in advance.

### Fourth Example of the First Aspect

A Fourth example of the First Aspect discloses a method that a UE 3 sends a Service Request message to an AMF 70 when a NAS layer 362 of the UE 3 receives UPLINK data from new application in the UE 3 even the UE 3 is in CM-CONNECTED and an indicated PDU session by the UE 3 has already been activated.

When the AMF 70 receives the Service Request message from the UE 3 including an application identifier (e.g. App_Id), the AMF 70 checks the application identifier whether it is consistent for use of the PDU session with the UE policy that is downloaded from a PCF 73.

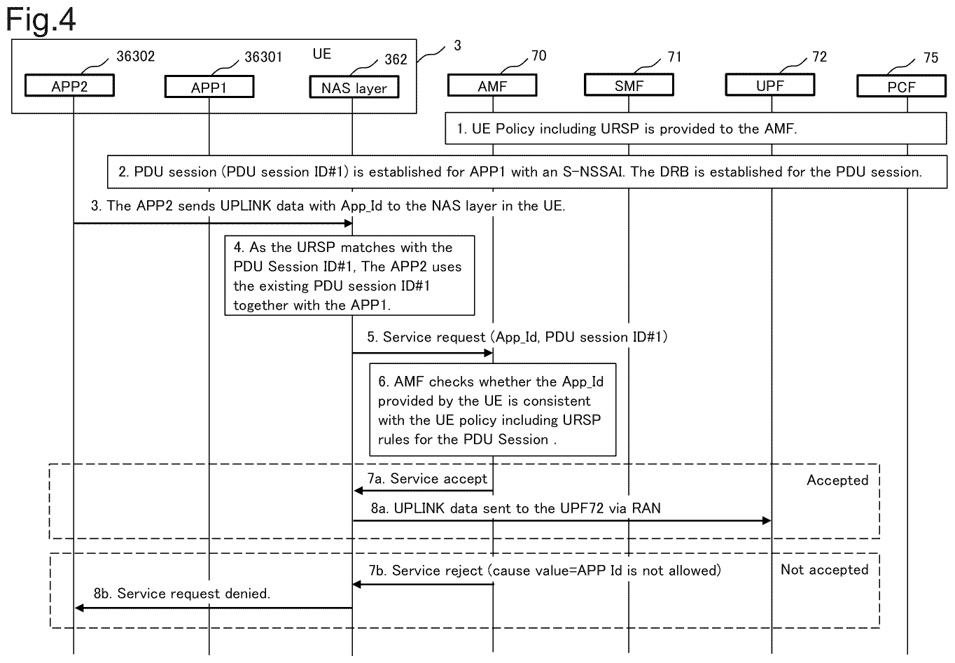

The detailed processes of the Forth example of the First Aspect are described below, with reference to FIG. 4.
Steps 1: The UE Policy including URSP rule(s) is provided to the AMF 70 by the PCF 73 as specified in steps 4 and 5 of the First example of the First Aspect. The UE Policy including URSP rule(s) may be provided to the AMF 70 by the PCF 73 as specified in steps 3 to 5 of the First example of the First Aspect. The AMF 70 may provide the UE Policy to the UE 3 as specified in step 6 of the First example of the First Aspect.
Step 2: A PDU Session (PDU session ID #1 is assigned to this PDU Session) is established for an APP1 36301 and a DRB has been established for the APP1 36301. I.e., The UE 3 is in CM-CONNECTED state. The PDU Session may be established for APP 1 36301 with an S-NSSAI. The APP 1 36301 is an application in the UE 3.
Steps 3: At some point, an APP2 36302 sends the UPLINK data to the NAS layer 362 with the APP_id of the APP2 36302. The APP 2 36302 is an application in the UE 3.

Note that the NAS layer 362 may be one of functionalities of the COMMUNICATIONS CONTROL MODULE 362 in the general block diagram for the UE.
Step 4: The NAS layer 362 checks the URSP rule(s) in the UE 3 whether the received App_Id from the APP2 36302 matches the existing PDU session (PDU Session ID #1) to be used for the APP2 36302. For example, the NAS layer 362 may check whether there is the URSP rule(s) corresponding to the received App_Id. For example, the NAS layer 362 may check whether there is the URSP rule(s) including a Traffic descriptor that corresponds to the received App_Id. In a case where the NAS layer 362 finds the URSP rule(s) corresponding to the received App_Id, the NAS layer 362 selects a Route Selection Descriptor within the found URSP rule(s). Then the NAS layer 362 determines whether the existing PDU session (PDU Session ID #1) matches components in the selected Route Selection Descriptor. For example, the NAS layer 362 may determine whether information regarding the existing PDU session (PDU Session ID #1) matches information regarding a PDU Session in the selected Route Selection Descriptor. If it matches (e.g. if the existing PDU session (PDU Session ID #1) matches components in the selected Route Selection Descriptor), then the NAS layer 362 proceeds with the following steps in the Fourth example of the First Aspect. Otherwise, the NAS layer 362 may initiate the UE Requested PDU session establishment procedure to establish new PDU session for the APP2 36302 as described in section 4.3.2.2 in NPL 4.
Step 5: The NAS layer 362 in the UE 3 sends a Service request message containing the PDU Session ID #1 (the PDU session identity 1) and the App_Id (application identity) of APP2 36302 to the AMF 70.
Step 6: Upon reception of the Service request message from the UE 3, the AMF 70 checks whether the App_Id provided by the UE 3 is consistent with the UE policy in the UE context of the UE 3 (for example, the AMF 70 checks whether the received application identity (i.e., the received App_Id) matches any route descriptor rule(s) defined in the NSSP corresponding to the application identity or whether the received App_Id matches any application identities in the URSP rule(s) or whether the received App_Id matches any application identities in “Application descriptors” of the URSP rule(s)).

When the AMF 70 checks whether the App_Id provided by the UE 3 is consistent with the UE policy, the AMF 70 may check the UE policy or the URSP rule(s) corresponding to the PDU Session ID #1.

If it is consistent with the UE policy (for example, if the received application identity (i.e., the received App_Id) matches one of route descriptor rule(s) defined in the NSSP corresponding to the application identity or if the received App_Id matches one of application identities in the URSP rule(s) or if the received App_Id matches one of application identities in “Application descriptors” of the URSP rule(s)), steps 7a and 8a take place, otherwise (for example, if the received application identity (i.e., the received App_Id) does not match any route descriptor rule(s) defined in the NSSP corresponding to the application identity or if the received App_Id does not match any application identities in the URSP rule(s) or if the received App_Id does not match any application identities in “Application descriptors” of the URSP rule(s)), steps 7b and 8b take place.
Step 7a: The AMF sends a Service accept message to the UE 3.
Step 8a: Upon reception of the Service accept message, the NAS layer 362 forwards the UPLINK data received from the APP2 36302 at step 3 to the UPF 72 via RAN.

After the Step 8a, subsequent UPLINK data from the APP2 36302 is forwarded by NAS layer 362 to the UPF 72 via the RAN using PDU session identified by the PDU session ID #1. Similarly, DOWNLINK data from the UPF 72 via the RAN is forwarded to the APP2 36302 by the NAS layer 362 if the DOWNLINK data destines to the APP2 36302.
Step 7b: The AMF 70 sends a Service reject message to the UE 3. The Service reject message includes a SM cause value which is set to “App_Id is not allowed” indicating that the PDU session ID #1 cannot be used by the APP2 36302 that is indicated as the App_Id in the Service request message in step 5.
Step 8b: Upon reception of the Service reject message including the SM cause value, the NAS layer 362 discards the UPLINK data received from the APP2 36302 at step 3 and sends a message to the APP2 36302 indicating that the App_Id specified in the step 3 is not valid.

Upon reception of the message from the NAS layer 362, the APP2 36302 stops sending UPLINK data to the NAS layer 362 and initiates the inspection program (for example, virus check program). At least one of the discarding the UPLINK data and the stopping sending UPLINK data may be referred to as stopping use of the APP2 36302.

According to the Fourth example of the First Aspect, for example, the 5GC (e.g. the AMF) can be aware whether or when the UE enforces a URSP rule(s). In addition, according to the Fourth example of the First Aspect, for example, it can provide actions that the 5GS (e.g. the AMF) can take after 5GC is aware whether the UE enforces a URSP rule(s). Further, according to the Fourth example of the First Aspect, for example, it can provide a solution which can prevent from unauthorized application(s) in the UE routing traffic via the existing PDU sessions.

For example, a communication terminal corresponding to UE 3 send, to a first apparatus, a service request message including information for an application for the communication terminal. For example, the first apparatus corresponding to AMF 70. The first apparatus stores policy information for the communication terminal from a second apparatus. For example, the second apparatus corresponding to PCF 73. The first apparatus checks whether the information for an application for the communication terminal is consistent with the policy information for a communication terminal. The first apparatus sends, to the communication terminal, information related to rejection in a case where the information for an application for the communication terminal is not consistent with the policy information for a communication terminal.

For example, a communication terminal corresponding to UE 3 send, to a first apparatus, a service request message including information for an application for the communication terminal. For example, the first apparatus corresponding to AMF 70. The first apparatus stores policy information for the communication terminal from a second apparatus. For example, the second apparatus corresponding to PCF 73. The first apparatus checks whether the information for an application for the communication terminal is consistent with the policy information for a communication terminal. The first apparatus sends, to the communication terminal, information related to acceptance in a case where the information for an application for the communication terminal is consistent with the policy information for a communication terminal.

For example, a first corresponding to the AMF 70 stores policy information for a communication terminal from a second apparatus. For example, the communication terminal corresponding to the UE 3. For example, the second apparatus corresponding to the PCF 73. The first apparatus receives, from the communication terminal, service request message including information for an application for the communication terminal. The first apparatus checks whether the information for an application for the communication terminal is consistent with the policy information for a communication terminal. The first apparatus sends, to the communication terminal, information related to rejection in a case where the information for an application for the communication terminal is not consistent with the policy information for a communication terminal.

For example, a first corresponding to the AMF 70 stores policy information for a communication terminal from a second apparatus. For example, the communication terminal corresponding to the UE 3. For example, the second apparatus corresponding to the PCF 73. The first apparatus receives, from the communication terminal, service request message including information for an application for the communication terminal. The first apparatus checks whether the information for an application for the communication terminal is consistent with the policy information for a communication terminal. The first apparatus sends, to the communication terminal, information related to acceptance in a case where the information for an application for the communication terminal is consistent with the policy information for a communication terminal.

### Fifth Example of the First Aspect

A Fifth example of the First Aspect discloses a method where an AMF 70 sends a first NAS message to a UE 3 requesting a list of associated application identifiers to an indicated PDU session. Once the AMF 70 receives a second NAS message including the list of associated application identifiers to the PDU session, the AMF 70 checks each application whether it is consistent for use of the PDU session with the UE policy that is downloaded from the PCF 73.

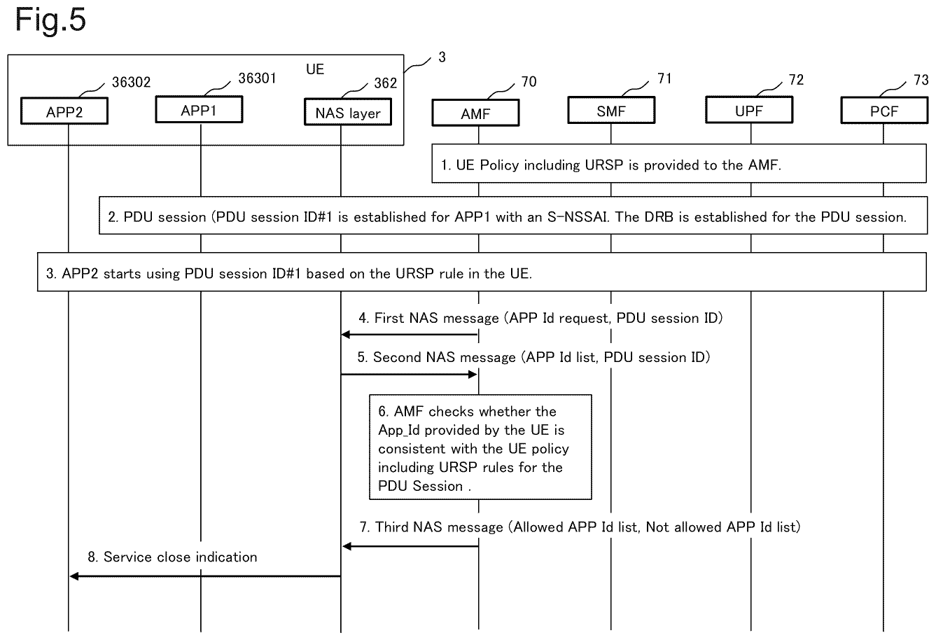

The detailed processes of the Fifth example of the First Aspect are described below, with reference to FIG. 5.
Steps 1: The UE Policy including URSP rule(s) is provided to the AMF 70 by the PCF 73 as specified in steps 4 and 5 of the First example of the First Aspect. The UE Policy including URSP rule(s) may be provided to the AMF 70 by the PCF 73 as specified in steps 3 to 5 of the First example of the First Aspect.
Step 2: A PDU Session (PDU session ID #1 is assigned to this PDU Session) is established for an APP1 36301 and a DRB has been established for the APP1 36301. I.e., The UE 3 is in CM-CONNECTED state. The PDU Session may be established for APP 1 36301 with an S-NSSAL. The APP 1 36301 is an application in the UE 3.
Step 3: At some point, an APP2 36302 starts using the PDU session as identified by the PDU session ID #1 based on the URSP rule(s) in the UE 3. The APP 2 36302 is an application in the UE 3.

In this example, the PDU session that is identified by the PDU session ID #1 is used by two applications such as the APP1 36301 and the APP2 36302.
Step 4: The AMF 70 sends a first NAS message to the UE 3 including a flag and PDU session ID. The flag indicates that a list of application(s) that uses PDU session(s) is requested. In case that the PDU session ID is not specified or explicitly indicated by another parameter, the first NAS message can apply to all PDU sessions that are established in the UE 3. The flag may be referred to as an APP ID request.

For example, the first NAS message can be a DL NAS transport message, an Identity request message, a Notification message, a 5GMM status message or another existing NAS message or new NAS message.

A trigger for the AMF 70 to send the first NAS message can be listed as follows.
Periodic activation. For example, once per day for each PDU session.
When the AMF 70 receives an indication from an SMF 71 or a UPF 72 that the UE 3 needs to be checked for a use of PDU session as user data traffic monitored in the UPF 72 is unusual. One example of the monitored unusual traffic is too much data in short period of time.
When the AMF 70 receives an indication from other node, for example an NWDAF 76, that the UE 3 needs to be checked for a use of PDU session as it is suspicious on a UE behavior.
Step 5: Upon reception of the first NAS message, the UE 3 sends a second NAS message to the AMF 70 including a list of App_Id and PDU session ID. The list of App_Id indicates that Applications as identified by the App_Id uses the PDU session as indicated by the PDU session ID. In case that the PDU session ID is not specified or explicitly indicated by another parameter in the first NAS message, the second NAS message includes a list of a parameter where the parameter includes a list of App_Id and PDU session ID.

For example, the second NAS message can be a UL NAS transport message, an Identity response message, a Notification response message, a 5GMM status message or another existing NAS message or new NAS message.

For example, in a case where the PDU session that is identified by the PDU session ID #1 is used by two applications such as the APP1 36301 and the APP2 36302 in the UE 3 and the UE 3 receives the first NAS message including the flag and the PDU session ID #1, the UE 3 may send the second NAS message including the list of App_Id and PDU session ID. In this case, the list may include App_Id of the APP1 36301, App_Id of the APP2 36302 and the PDU session ID #1. The list may indicate that the PDU session ID #1 (or the PDU Session identified by the PDU session ID #1) is used by the APP1 36301 which is identified by App_Id 1 and the APP2 36302 which is identified by App_Id 2.
Step 6: Upon reception of the second NAS message from the UE 3, the AMF 70 checks whether the App_Id provided by the UE 3 is consistent with the UE policy in the UE context of the UE 3 (for example, the AMF 70 checks whether the received application identity (i.e., the received App_Id) matches any route descriptor rule(s) defined in the NSSP corresponding to the application identity or whether the received App_Id matches any application identities in “Application descriptors” of the URSP rule(s)).

When the AMF 70 checks whether the App_Id provided by the UE 3 is consistent with the UE policy, the AMF 70 may check the UE policy or the URSP rule(s) corresponding to the PDU Session ID received in step 5.

If it is not consistent with the UE policy (for example, if the received application identity (i.e., the received App_Id) does not match any route descriptor rule(s) defined in the NSSP corresponding to the application identity or if the received App_Id does not match any application identities in the URSP rule(s) or if the received App_Id does not match any application identities in “Application descriptors” of the URSP rule(s)), steps 7 and 8 take place, otherwise (for example, if the received application identity (i.e., the received App_Id) matches one of route descriptor rule(s) defined in the NSSP corresponding to the application identity or if the received App_Id matches one of application identities in the URSP rule(s) or if the received App_Id matches one of application identities in “Application descriptors” of the URSP rule(s)) the AMF 70 does nothing.

In a case where the AMF 70 receives two or more App_Ids, the AMF 70 may determine whether each of the App_Ids matches the URSP rule(s). In a case where at least one of the App_Ids does not match the URSP rule(s), steps 7 and 8 may take place.
Step 7: The AMF 70 sends a third NAS message to the UE 3 including a list of allowed APP_Id, a list of not allowed APP_Id and PDU session ID. In case that the PDU session ID is not specified or explicitly indicated by another parameter in the first NAS message, the third NAS message includes a list of a parameter where the parameter includes a list of allowed APP_Id, a list of not allowed APP_Id and PDU session ID.

For example, the third NAS message can be a DL NAS transport message, an Identity request message, a Notification message, a 5GMM status message or another existing NAS message or new NAS message.

For example, it assumes a case where the PDU session that is identified by the PDU session ID #1 is used by two applications such as the APP1 36301 and the APP2 36302 in the UE 3. In this example, in a case where App_Id 1 of the APP1 36301 matches the URSP rule(s) and App_Id 2 of the APP2 36302 does not match the URSP rule(s), the third NAS message may include the list of allowed APP_Id including App_Id 1, the list of not allowed APP_Id including App_Id 2 and the PDU session ID #1. In a case where the App_Id 1 and the App_Id 2 match the URSP rule(s), the third NAS message may include the list of allowed APP_Id including the App_Id 1 and the App_Id 2, and the the PDU session ID #1. In a case where the App_Id 1 and the App_Id 2 do not match the URSP rule(s), the third NAS message may include the list of not allowed APP_Id including the App_Id 1 and the App_Id 2, and the the PDU session ID #1.
Step 8: Upon reception of the third NAS message, the NAS layer 362 performs as follows.

In a case where the third NAS message includes the list of not allowed APP_Id, the NAS layer 362 generates a Service close indication message and send the message to an application which is identified by the App_Id included in the list of not allowed APP_Id. The Service close indication message may indicate that the PDU session being used is not appropriate.

For example, in a case where the third NAS message includes the list of not allowed APP_Id which includes App_Id 2 of the APP2 36302, the NAS layer 362 may send the Service close indication message to the APP2 36302.

Upon reception of the Service close indication message from the NAS layer 362, the APP2 36302 stops sending UPLINK data to the NAS layer 362 and initiates the inspection program (for example, virus check program).

If the third NAS message indicates multiple applications to be stopped (e.g. if the list of not allowed APP_Id of the third NAS message includes multiple App_Ids), the NAS layer 362 sends multiple Service close indication messages to applications respectively based on the parameter (e.g. the App_Ids) received in the third NAS message.

The at least one of the generating the Service close indication message, the sending the Service close indication message and the stopping sending UPLINK data may be referred to as stopping use of the APP2 36302.

In a case where the application does not receive the Service close indication message, the application may continue sending UPLINK data to the NAS layer 362.

In a case where the NAS layer 362 receives the list of allowed APP_Id, the NAS layer 362 may generate a Service continue indication message and send the message to an application that is identified by the App_Id included in the list of allowed APP_Id. The Service continue indication message may indicate that the PDU session being used is appropriate.

Upon reception of the Service continue indication message from the NAS layer 362, the application may continue sending UPLINK data to the NAS layer 362.

According to the Fifth example of the First Aspect, for example, the 5GC (e.g. the AMF) can be aware whether or when the UE enforces a URSP rule(s). In addition, according to the Fifth example of the First Aspect, for example, it can provide actions that the 5GS (e.g. the AMF) can take after 5GC is aware whether the UE enforces a URSP rule(s). Further, according to the Fifth example of the First Aspect, for example, it can provide a solution which can prevent from unauthorized application(s) in the UE routing traffic via the existing PDU sessions.

For example, a first apparatus corresponding to AMF 70 stores policy information for a communication terminal from a second apparatus. For example, the communication terminal corresponding to the UE 3. For example, the second apparatus corresponding to the PCF 72. The first apparatus sends, to the communication terminal, a request message for information for an application for the communication terminal. The first apparatus receives, from the communication terminal, the information for an application for the communication terminal. The first apparatus checks whether the information for an application for the communication terminal is consistent with the policy information for the communication terminal. The first apparatus sends, to the communication terminal, information related to rejection in a case where the information for an application for the communication terminal is not consistent with the policy information for the communication terminal.

For example, a first apparatus corresponding to AMF 70 stores policy information for a communication terminal from a second apparatus. For example, the communication terminal corresponding to the UE 3. For example, the second apparatus corresponding to the PCF 72. The first apparatus sends, to the communication terminal, a request message for information for an application for the communication terminal. The first apparatus receives, from the communication terminal, the information for an application for the communication terminal. The first apparatus checks whether the information for an application for the communication terminal is consistent with the policy information for the communication terminal. The first apparatus sends, to the communication terminal, information related to acceptance in a case where the information for an application for the communication terminal is consistent with the policy information for the communication terminal.

### Variant 1 of the Fifth Example of the First Aspect

In one example, the steps 4-7 are executed by an SMF 71 or a UPF 72 as well. E.g. the UPF 72 or the SMF 71 may determine whether the data being transmitted over the PDU session (e.g. the App_Id) matches the URSP rule(s) which the UPF 72 or the SMF 71 receives as defined in one of the above Aspects.

### <System Overview>

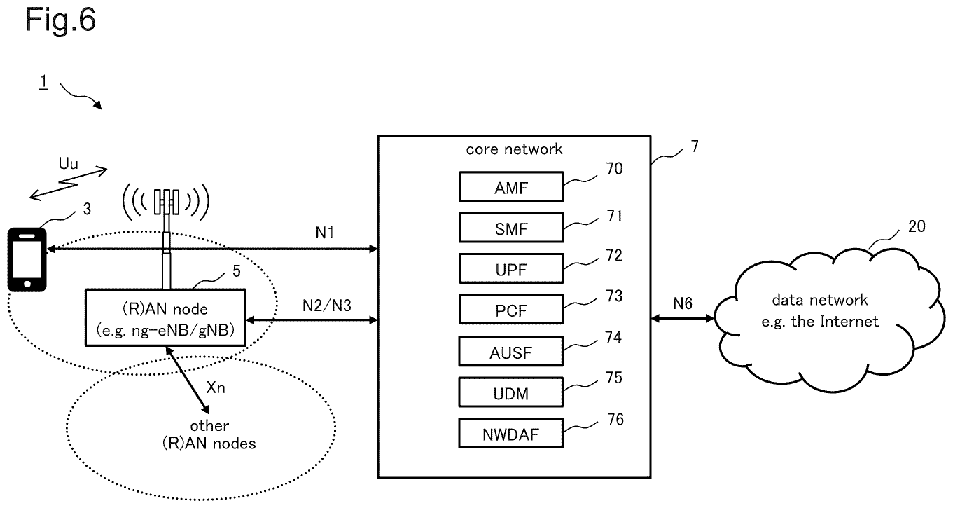

FIG. 6 schematically illustrates a telecommunication system 1 for a mobile (cellular or wireless) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into control plane function and user plane function. Further, multiple user plane functions can be allocated to support a communication. In some aspects, user traffic may be distributed to multiple user plane functions and user traffic over each user plane functions are aggregated in both the UE 3 and the (R)AN node 5. This split architecture may be called as ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in logical nodes can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, a Authentication Server Function (AUSF) 74, a Unified Data Management (UDM) 75, and a Network Data Analytics Function (NWDAF) 76. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN node 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPv4, IPv6, IPv4v6, Ethernet or unstructured data type.

The “Uu” interface may include a Control plane of Uu interface and User plane of Uu interface.

The User plane of Uu interface is responsible to convey user traffic between the UE 3 and a serving (R)AN node 5. The User plane of Uu interface may have a layered structure with SDAP, PDCP, RLC and MAC sublayer over the physical connection.

The Control plane of Uu interface is responsible to establish, modify and release a connection between the UE 3 and a serving (R)AN node 5. The Control plane of Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by Aspects in this disclosure, following parameters may be included together in the RRC Setup Request message.
establishmentCause and ue-Identity. The ue-Identity may have a value of ng-5G-S-TMSI-Part1 or randomValue.
RRC Setup message: This message is sent from the (R)AN node 5 to the UE 3. In addition to the parameters that are disclosed by Aspects in this disclosure, following parameters may be included together in the RRC Setup message.
masterCellGroup and radioBearerConfig
RRC setup complete message: This message is sent from the UE 3 to the (R)AN node 5. In addition to the parameters that are disclosed by Aspects in this disclosure, following parameters may be included together in the RRC setup complete message.
guami-Type, iab-NodeIndication, idleMeasAvailable, mobilityState, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible to provide a communication between the UE 3 and the AMF 70 to support NAS signaling. The N1 interface may be established over a 3GPP access and over a non-3GPP access. For example, the following messages are communicated over the N1 interface.
registration request message: This message is sent from the UE 3 to the AMF 70. In addition to the parameters that are disclosed by Aspects in this disclosure, following parameters may be included together in the registration request message.
5GS registration type, ngKSI, 5GS mobile identity, Non-current native NAS key set identifier, 5GMM capability, UE security capability, Requested NSSAI, Last visited registered TAI, Si UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
registration accept message: This message is sent from the AMF 70 to the UE 3. In addition to the parameters that are disclosed by Aspects in this disclosure, following parameters may be included together in the registration accept message.
5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by Aspects in this disclosure, following parameters may be included together in the Registration Complete message.
SOR transparent container.
Authentication Request message: This message is sent from the AMF 70 to the UE 3. In addition to the parameters that are disclosed by Aspects in this disclosure, following parameters may be included together in the Authentication Request message.
ngKSI, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by Aspects in this disclosure, following parameters may be populated together in the Authentication Response message.
Authentication response message identity, Authentication response parameter and EAP message.
Authentication Result message: This message is sent from the AMF 70 to the UE 3. In addition to the parameters that are disclosed by Aspects in this disclosure, following parameters may be populated together in the Authentication Result message.
ngKSI, EAP message and ABBA.
Authentication Failure message: This message is sent from the UE 3 to the AMF 70. In addition to the parameters that are disclosed by Aspects in this disclosure, following parameters may be populated together in the Authentication Failure message.
Authentication failure message identity, 5GMM cause and Authentication failure parameter.
Authentication Reject message: This message is sent from the AMF 70 to the UE 3. In addition to the parameters that are disclosed by Aspects in this disclosure, following parameters may be populated together in the Authentication Reject message.
EAP message.
Service Request message: This message is sent from the UE 3 to the AMF 70. In addition to the parameters that are disclosed by Aspects in this disclosure, following parameters may be populated together in the Service Request message.
ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, following parameters may be populated together in the Service Accept message.
PDU session status, PDU session reactivation result, PDU session reactivation result error cause, EAP message and T3448 value.
Service Reject message: This message is sent from the AMF 70 to the UE 3. In addition to the parameters that are disclosed by Aspects in this disclosure, following parameters may be populated together in the Service Reject message.
5GMM cause, PDU session status, T3346 value, EAP message, T3448 value and CAG information list.
Configuration Update Command message: This message is sent from the AMF 70 to the UE 3. In addition to the parameters that are disclosed by Aspects in this disclosure, following parameters may be populated together in the Configuration Update Command message.
Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by Aspects in this disclosure, following parameters may be populated together in the Configuration Update Complete message.
Configuration update complete message identity.

### <User Equipment (UE)>

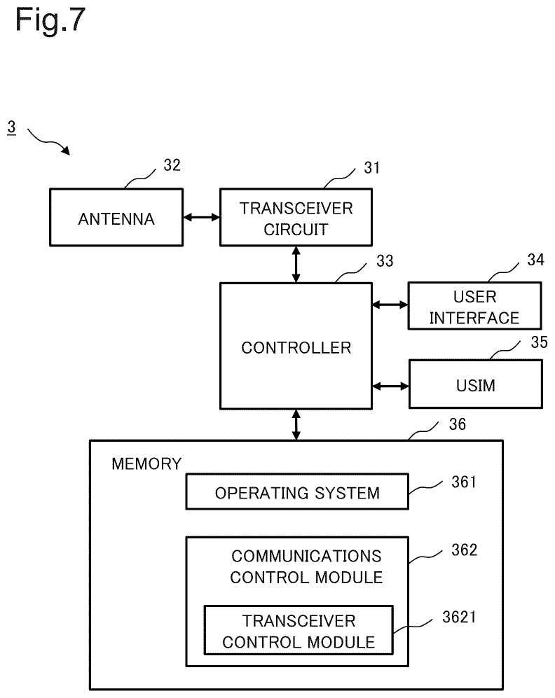

FIG. 7 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the Figure, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361, an application 363 and a communications control module 362 having at least a transceiver control module 3621. The application 363 is an application that provides service(s) to user(s) of the UE 3 and/or provides machine type of services. The application 363 generates uplink data packets and sends them via the antenna 32 by communicating with the communications control module 362. In contrast, the application 363 receives downlink data packets from the communications control module 362 if downlink data packets received by the antenna 32 destine to the application 363. There may be one or multiple application 363 in the memory 36. The application 363 may include APP1 (application 1) 36301 and APP2 (application 2) 36302. The communications control module 362 (using its transceiver control module 3621) is responsible for handling (generating/sending/receiving) signalling and uplink/downlink data packets between the UE 3 and other nodes, such as the (R)AN node 5 and the AMF 70. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

### <(R)an Node>

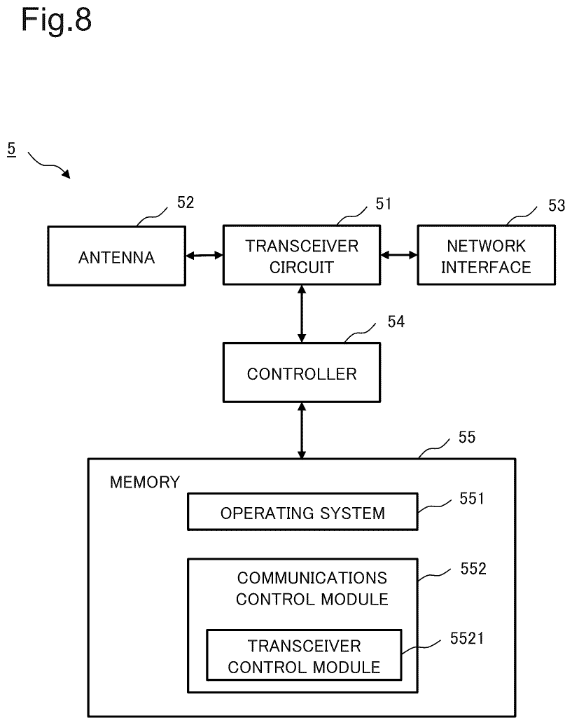

FIG. 8 is a block diagram illustrating the main components of an exemplary (R)AN node 5, for example a base station (‘eNB’ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimates and/or moving trajectory estimation.

The (R)AN node 5 may support the Non-Public Network (NPN), The NPN may be a Stand-alone Non-Public Network (SNPN) or a Public Network Integrated NPN (PNI-NPN). A Master Node (MN) 501 and a Secondary Node (SN) 502 may have same components to the (R)AN node 5.

### <System Overview of (R)AN Node 5 Based on O-RAN Architecture>

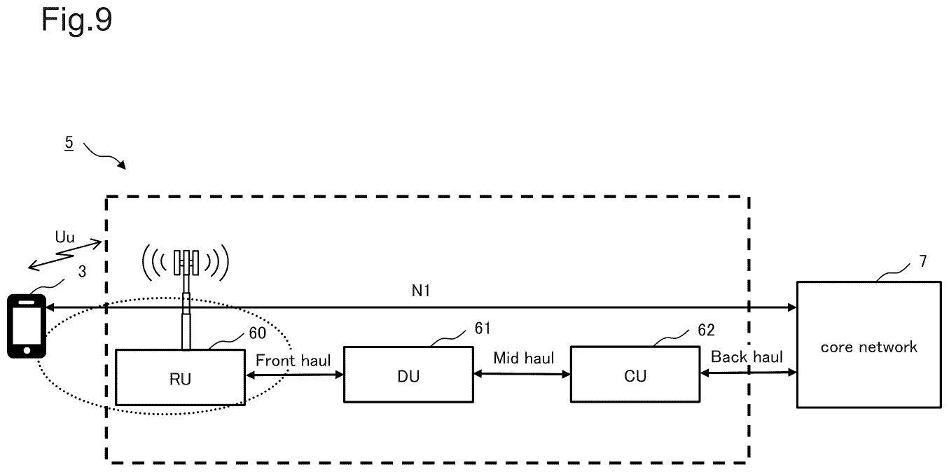

FIG. 9 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide functionalities to communicate with a UE 3 over air interface, the DU 61 may provide functionalities to support MAC layer and RLC layer, the CU 62 may provide functionalities to support PDCP layer, SDAP layer and RRC layer.

### <Radio Unit (RU)>

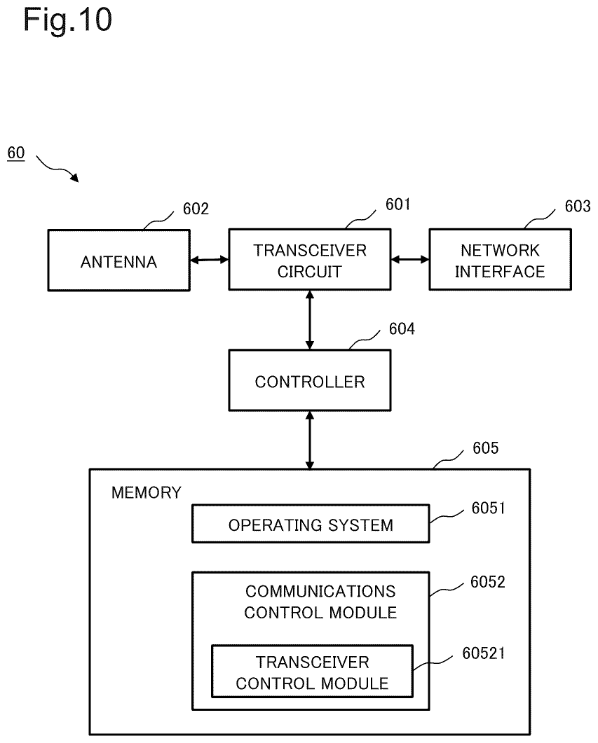

FIG. 10 is a block diagram illustrating the main components of an exemplary RU 60, for example a RU part of base station (‘eNB’ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (RMD), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimates and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### <Distributed Unit (DU)>

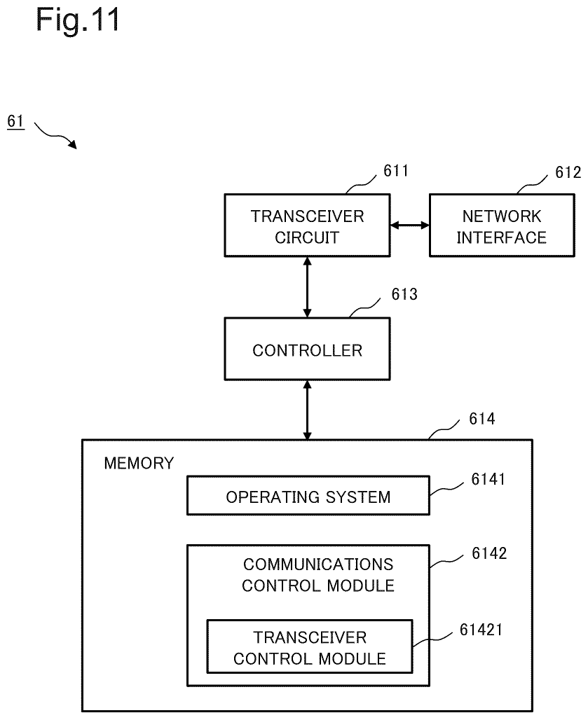

FIG. 11 is a block diagram illustrating the main components of an exemplary DU 61, for example a DU part of a base station (‘eNB’ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 or CU 62 as an integrated/combined unit. Any functionality in the description for DU 61 can be implemented in one of the integrated/combined unit above.

### <Centralized Unit (CU)>

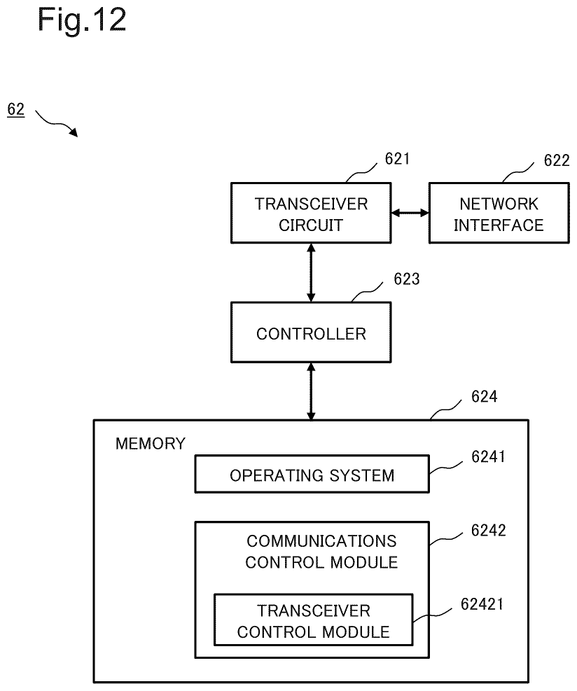

FIG. 12 is a block diagram illustrating the main components of an exemplary CU 62, for example a CU part of base station (‘eNB’ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### <AMF>

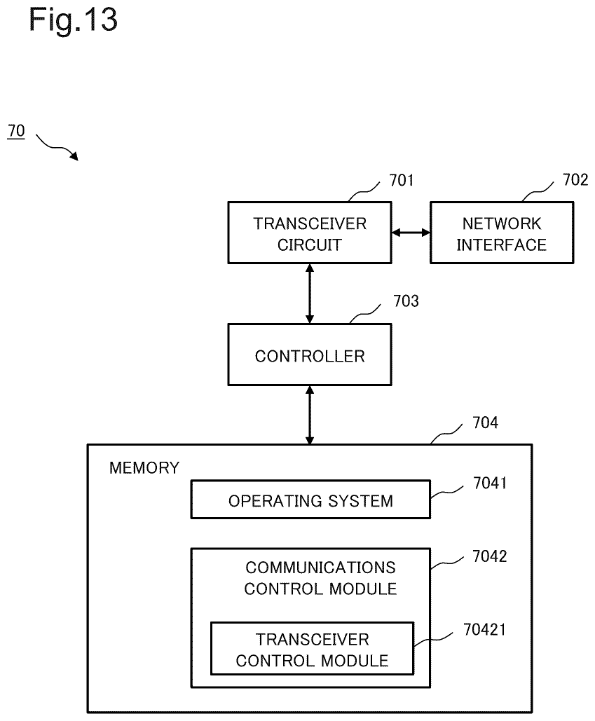

FIG. 13 is a block diagram illustrating the main components of the AMF 70. As shown, the apparatus includes a transceiver circuit 701 which is operable to transmit signals to and to receive signals from other nodes (including the UE 3, the RAN 5, the SMF 71) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g. via the (R)AN node 5) and other core network nodes (including core network nodes in the HPLMN of the UE 3 when the UE 3 is roaming-in. Such signalling may include, for example, appropriately formatted signalling messages (e.g. a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN). An AMF 7001 and an AMF 7002 may have same components to the AMF 70.

### <SMF>

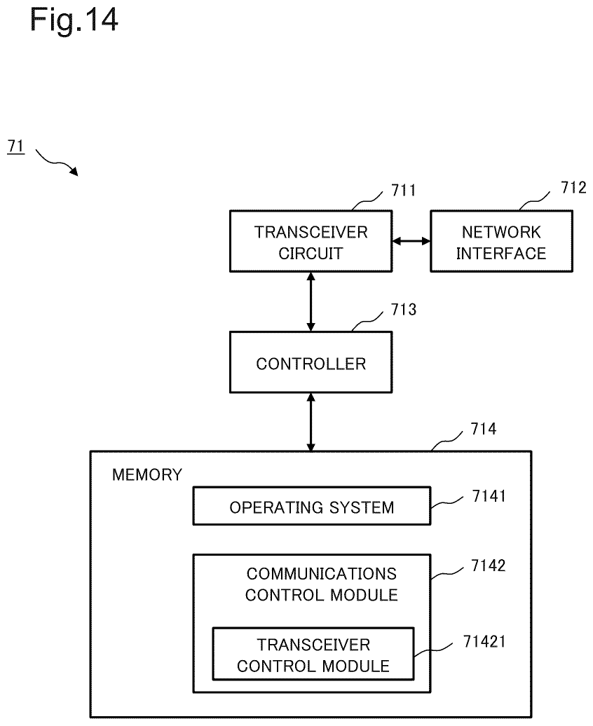

FIG. 14 is a block diagram illustrating the main components of the SMF 71. As shown, the apparatus includes a transceiver circuit 711 which is operable to transmit signals to and to receive signals from other nodes (including the AMF 70, the UPF 72) via a network interface 712. A controller 713 controls the operation of the SMF 71 in accordance with software stored in a memory 714. Software may be pre-installed in the memory 714 and/or may be downloaded via the telecommunication network or from a removable data storage device (RMD), for example. The software includes, among other things, an operating system 7141 and a communications control module 7142 having at least a transceiver control module 71421. The communications control module 7142 (using its transceiver control module 71421 is responsible for handling (generating/sending/receiving) signalling between the SMF 71 and other nodes, such as the UPF 72 and other core network nodes (including core network nodes in the HPLMN of the UE 3 when the UE 3 is roaming-in. Such signalling may include, for example, appropriately formatted signalling messages (e.g. a Hypertext Transfer Protocol (HTTP) restful methods based on the service based interfaces) relating to session management procedures (for the UE 3).

The SMF 71 may support the Non-Public Network (NPN), The NPN may be a Stand-alone Non-Public Network (SNPN) or a Public Network Integrated NPN (PNI-NPN).

### <UPF>

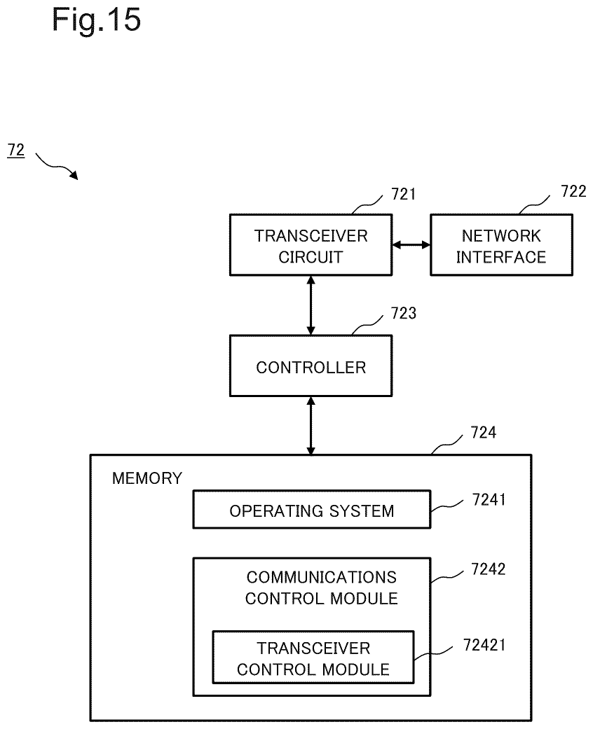

FIG. 15 is a block diagram illustrating the main components of the UPF 72. As shown, the apparatus includes a transceiver circuit 721 which is operable to transmit signals to and to receive signals from other nodes (including the SMF 71) via a network interface 722. A controller 723 controls the operation of the UPF 72 in accordance with software stored in a memory 724. Software may be pre-installed in the memory 724 and/or may be downloaded via the telecommunication network or from a removable data storage device (e.g. a removable memory device (RMD)), for example. The software includes, among other things, an operating system 7241 and a communications control module 7242 having at least a transceiver control module 72421. The communications control module 7242 (using its transceiver control module 72421 is responsible for handling (generating/sending/receiving) signalling between the UPF 72 and other nodes, such as the SMF 71 and other core network nodes (including core network nodes in the HPLMN of the UE 3 when the UE 3 is roaming-in. Such signalling may include, for example, appropriately formatted signalling messages (e.g. a GPRS Tunneling Protocol (GTP) for User plane) relating to User data handling (for the UE 3).

The UPF 72 may support the Non-Public Network (NPN), The NPN may be a Stand-alone Non-Public Network (SNPN) or a Public Network Integrated NPN (PNI-NPN).

The collocated gNB-CU-UP and UPF or the communication apparatus executing function of a collocated gNB-CU-UP and UPF or the communication apparatus executing function of the gNB-CU-UP and function of the UPF may have same components to the UPF 72.

### <PCF>

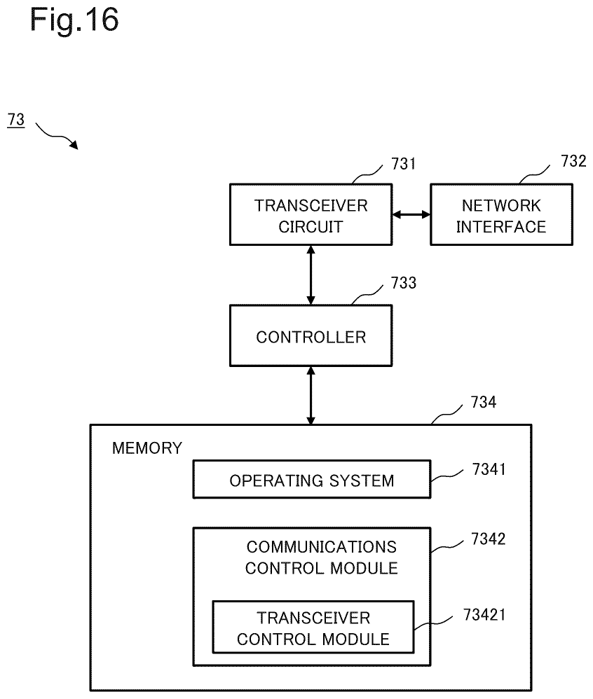

FIG. 16 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (e.g. a removable memory device (RMD)), for example. The software includes, among other things, an operating system 7341 and a communications control module 7342 having at least a transceiver control module 73421. The communications control module 7342 (using its transceiver control module 73421 is responsible for handling (generating/sending/receiving) signalling between the PCF 73 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The PCF 73 may support the Non-Public Network (NPN), The NPN may be a Stand-alone Non-Public Network (SNPN) or a Public Network Integrated NPN (PNI-NPN). A PCF 7301 and a PCF 7302 may have same components to the PCF 73.

### <AUSF>

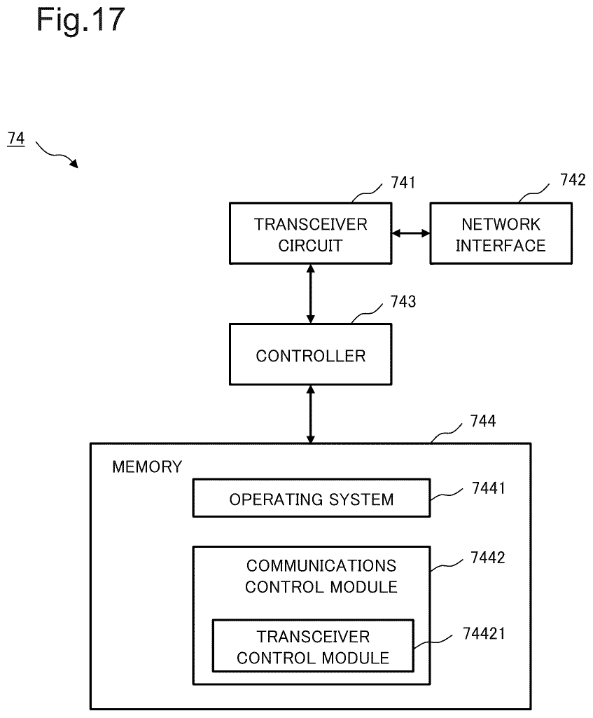

FIG. 17 is a block diagram illustrating the main components of the AUSF 74. As shown, the apparatus includes a transceiver circuit 741 which is operable to transmit signals to and to receive signals from other nodes (including the UDM 75) via a network interface 742. A controller 743 controls the operation of the AUSF 74 in accordance with software stored in a memory 744. Software may be pre-installed in the memory 744 and/or may be downloaded via the telecommunication network or from a removable data storage device (e.g. a removable memory device (RMD)), for example. The software includes, among other things, an operating system 7441 and a communications control module 7442 having at least a transceiver control module 74421. The communications control module 7442 (using its transceiver control module 74421 is responsible for handling (generating/sending/receiving) signalling between the AUSF 74 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The AUSF 74 may support the Non-Public Network (NPN), The NPN may be a Stand-alone Non-Public Network (SNPN) or a Public Network Integrated NPN (PNI-NPN).

### <UDM>

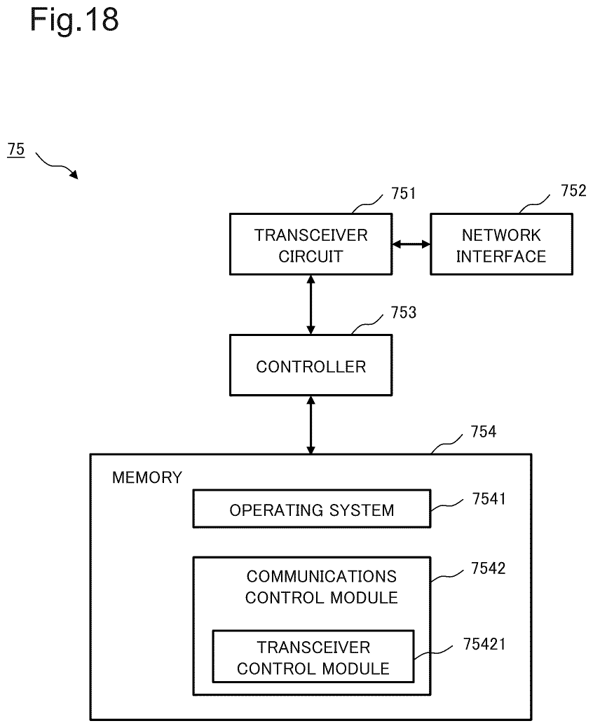

FIG. 18 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

The whole or part of the example Aspects disclosed above can be described as, but not limited to, the following.

### 1 Background

This contribution proposes a solution to Key Issue #2: 5GC awareness of URSP enforcement.

### 6.X Solution #X: UE URSP Enforcement Validation by the Network

### 6.X.1 Description

Editor's note: This clause will describe the solution principles and architecture assumptions for corresponding

This solution addresses the bellow requirements from Key Issue #2: 5GC awareness of URSP enforcement.
Whether and how the 5GC can be made aware whether or when the UE enforces a URSP rule to route an application traffic to a PDU Session based on the URSP rule provisioned by 5GC.
Whether there are any actions the 5GS can take after 5GC is aware whether the UE enforces a URSP rule for specific application traffic or not. If any, what action 5GC should take?

The solution allows for UE enforcement to follow correctly the URSP rules for traffic matching. It introduces Application identity parameter provisioned to the PCF by the UE during PDU Session Establishment procedure. The PCF performs URSP validity check in order to validate whether the UE correctly enforces the traffic matching rules in the URSP for the Application requiring the service. If the PCF finds out that the URSP rules are not correctly followed by the UE, the PDU Session is rejected with a new cause to indicate that the URSP rules in general or a specific URSP rules are not followed. Also, the PCF may optionally trigger UE Policy Update procedure to refresh the URSP rules in the UE with the latest version of the URSP rules.

### 6.X.2 Procedures

Editor's note: This clause describes high-level procedures and information flows for the solution.

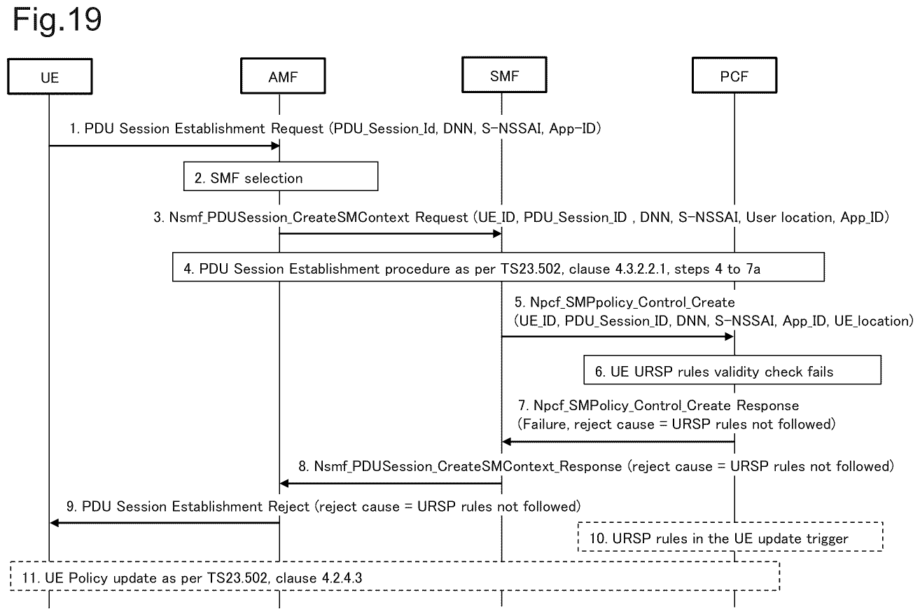

FIG. 6.X.2: UE's URSP enforcement validation by the network (See FIG. 19)
1. An Application in the UE requires service. The UE initiates PDU Session Establishment Request message in which the UE includes the UE_ID, the PDU Session ID, the S-NSSAI and the DNN. The UE selects the S-NSSAI and the DNN based on the URSP rules applicable for the Application requiring service. The UE also includes the App_ID of the Application in the PDU Session Establishment Request message.
2. SMF selection by the AMF.
3. The AMF invokes either Nsmf_PDUSession_CreateSMContext_Request message to the SMF if there is no association with it or Nsmf_PDUSession_UpdateSMContext_Request message if the AMF is already associated with a SMF. Along with the UE_ID, the S-NSSAI, the DNN and the User location parameters, the AMF also forwards to the SMF the App_ID received by the UE.
4. Continue with PDU Session Establishment procedure as per TS23.502, clause 4.3.2.2.1, steps 4 to 7a.
5. The SMF initiates the SM Policy Association Establishment procedure and the SMF sends the Npcf_SMPpolicy_Control_Create message to the PCF in which the SMF includes the UE_ID, the S-NSSAI, the DNN, the User location and the App_ID parameters.
6. The PCF performs URSP validity check for the UE. The PCF retrieves the stored latest version of the URSP rules for the UE and the PCF verifies whether the UE is following correctly the S-NSSAI selection rules, the DNN selector rules, the Time window criteria and the Location criteria.
7. If the result from the URSP validity check by the PCF is that one or more of the traffic matching rules in the latest version of the URSP are not correctly followed by the UE, the PCF returns Failure parameter in the Npcf_SMPpolicy_Control_Create response to the SMF. The PCF may also include the cause for the failure, e.g. URSP rules not followed or a more specific reject cause identifying the specific URSP rule that is not followed by the UE.
8. The SMF forwards the reject cause to the AMF in the Nsmf_PDUSession_CreateSMContext_Response message.
9. The AMF rejects the PDU Session Establishment Request from the UE and the AMF includes a rejection cause URSP rules not followed or a more specific reject cause pointing to which URSP rules are not followed (e.g. S-NSSAI selection rules not followed or DNN selection rules not followed or Time windows criteria not followed or Location criteria not followed).
10. If at step 6 the URSP validity check by the PCF fails, the PCF may assume the UE may not have the latest URSP rules so, the PCF may trigger UE Policy update procedure as per TS23.502, clause 4.2.4.3 in order to refresh the UE with the latest URSP rules.
11. UE Policy update as per TS23.502, clause 4.2.4.3

### 6.X.3 Impacts on Services, Entities and Interfaces

Editor's note: This clause captures impacts on existing 3GPP nodes and functional elements.

UE, AMF, SMF—new App_ID parameter and a new PDU Session Establishment reject cause.

PCF—new App Id parameter and URSP validity check functionality.

### <Modifications and Alternatives>

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

As will be appreciated by one of skill in the art, the present disclosure may be embodied as a method, and system. Accordingly, the present disclosure may take the form of an entirely hardware embodiment, a software embodiment or an embodiment combining software and hardware aspects.

It will be understood that each block of the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS (e.g., 6G system, 5G beyond system).

### <Supplementary Notes>

The whole or part of the example Aspects disclosed above can be described as, but not limited to, the following supplementary notes.

### Supplementary Note 1.

A method of a communication apparatus, the method comprising:
receiving a policy for a user equipment (UE);
receiving information related to an application in the UE from the UE;
checking whether the information is consistent with the policy; and sending a reject message in a case where the information is not consistent with the policy.

### Supplementary Note 2.

A method of a user equipment (UE), the method comprising:

sending a first message,

wherein the first message includes first information related to an application in the UE;

receiving a second message after sending the first message,

wherein the second message includes second information, and

wherein the second information indicates that the application is rejected; and

stopping use of the application in a case of receiving the second message.

### Supplementary Note 3.

A method of a communication apparatus, the method comprising:

receiving a policy for a user equipment (UE) and information indicating that checking of data of the UE is needed;

checking whether the data is consistent with the policy after receiving the information; and

performing deactivation of communication related to the data in a case where the data is not consistent with the policy.

### Supplementary Note 4.

A method of a communication apparatus, the method comprising:

receiving a policy for a user equipment (UE);

receiving a service request message,

wherein the service request message includes an identifier of an application in the UE;

checking whether the identifier is consistent with the policy;

sending an accept message in a case where the identifier is consistent with the policy; and

sending a reject message in a case where the identifier is not consistent with the policy.

### Supplementary Note 5.

A method of a user equipment (UE), the method comprising:

sending a service request message in a case where the UE has an established PDU session,

wherein the service request message includes an identifier of an application in the UE;

receiving a first message after sending the service request message;

sending data in a case where the first message is an accept message; and

stopping use of the application in a case where the first message is a reject message.

### Supplementary Note 6.

A method of a communication apparatus, the method comprising:

receiving a policy for a user equipment (UE);

sending a request to send an identifier of an application in the UE;

receiving the identifier;

checking whether the identifier is consistent with the policy; and

sending a message after checking whether the identifier is consistent with the policy,

wherein the message includes at least one of information indicating an application to be allowed and information indicating an application to be not allowed.

### Supplementary Note 7.

A method of a user equipment (UE), the method comprising:

receiving a request to send an identifier of an application in the UE;

sending the identifier;

receiving a message after sending the identifier,

wherein the message includes at least one of information indicating an application to be allowed and information indicating an application to be not allowed; and

stopping use of the application to be not allowed after receiving the message.

### Supplementary Note 8.

A communication apparatus comprising:

means for receiving a policy for a user equipment (UE);

means for receiving information related to an application in the UE from the UE;

means for checking whether the information is consistent with the policy; and

means for sending a reject message in a case where the information is not consistent with the policy.

### Supplementary Note 9.

A user equipment (UE) comprising:

means for sending a first message,

wherein the first message includes first information related to an application in the UE;

means for receiving a second message after sending the first message,

wherein the second message includes second information, and

wherein the second information indicates that the application is rejected; and

means for stopping use of the application in a case of receiving the second message.

### Supplementary Note 10.

A communication apparatus comprising:

means for receiving a policy for a user equipment (UE) and information indicating that checking of data of the UE is needed;

means for checking whether the data is consistent with the policy after receiving the information; and

means for performing deactivation of communication related to the data in a case where the data is not consistent with the policy.

### Supplementary Note 11.

A communication apparatus comprising:

means for receiving a policy for a user equipment (UE);

means for receiving a service request message,

wherein the service request message includes an identifier of an application in the UE;

means for checking whether the identifier is consistent with the policy;

means for sending an accept message in a case where the identifier is consistent with the policy; and

means for sending a reject message in a case where the identifier is not consistent with the policy.

### Supplementary Note 12.

A user equipment (UE) comprising:

means for sending a service request message in a case where the UE has an established PDU session,

wherein the service request message includes an identifier of an application in the UE;

means for receiving a first message after sending the service request message;

means for sending data in a case where the first message is an accept message; and

means for stopping use of the application in a case where the first message is a reject message.

### Supplementary Note 13.

A communication apparatus comprising:

means for receiving a policy for a user equipment (UE);

means for sending a request to send an identifier of an application in the UE;

means for receiving the identifier;

means for checking whether the identifier is consistent with the policy; and

means for sending a message after checking whether the identifier is consistent with the policy,

wherein the message includes at least one of information indicating an application to be allowed and information indicating an application to be not allowed.

### Supplementary Note 14.

A user equipment (UE) comprising:

means for receiving a request to send an identifier of an application in the UE;

means for sending the identifier;

means for receiving a message after sending the identifier,

wherein the message includes at least one of information indicating an application to be allowed and information indicating an application to be not allowed; and

means for stopping use of the application to be not allowed after receiving the message.

### Supplementary Note 15

A method for a first apparatus comprising:

receiving, from a second apparatus, policy information for a communication terminal;

receiving, from the communication terminal, information for an application for the communication terminal;

checking, whether the information for an application for the communication terminal is consistent with the policy information for a communication terminal; and

sending, to the communication terminal, information related to rejection in a case where the information for an application for the communication terminal is not consistent with the policy information for a communication terminal.

### Supplementary Note 16

A method for a third apparatus comprising;

storing policy information for a communication terminal from a second apparatus;

receiving, from the communication terminal, information for an application for the communication terminal;

checking, whether the information for an application for the communication terminal is consistent with the policy information for a communication terminal; and

sending, to a first apparatus, information related to rejection in a case where the information for an application for the communication terminal is not consistent with the policy information for a communication terminal.

### Supplementary Note 17.

A method for a fourth apparatus comprising;

storing policy information for a communication terminal from a second apparatus;

receiving, from a third apparatus for session management, information for an application for the communication terminal;

receiving, from the third apparatus for session management, information indicates checking data related to a communication terminal is needed;

checking, whether the information for an application for the communication terminal is consistent with the policy information for a communication terminal (UE) based on the information indicates checking data related to the communication terminal is needed; and

sending information related to rejection in a case where the information for an application for the communication terminal is not consistent with the policy information for a communication terminal.

### Supplementary Note 18.

A method for a communication terminal comprising:

sending, to a first apparatus, a service request message including information for an application for the communication terminal,

wherein the first apparatus stores policy information for a communication terminal from a second apparatus,

wherein the first apparatus checks, whether the information for an application for the communication terminal is consistent with the policy information for a communication terminal, and

wherein the first apparatus sends, to the communication terminal information related to rejection in a case where the information for an application for the communication terminal is not consistent with the policy information for a communication terminal.

### Supplementary Note 19.

A method for a communication terminal comprising:

sending, to a first apparatus, service request message including information for an application for the communication terminal,

wherein the first apparatus stores policy information for a communication terminal from a second apparatus,

wherein the first apparatus checks, whether the information for an application for the communication terminal is consistent with the policy information for a communication terminal, and

wherein the first apparatus sends information, to the communication terminal, related to acceptance in a case where the information for an application for the communication terminal is consistent with the policy information for a communication terminal.

### Supplementary Note 20.

A method for a first apparatus comprising:

storing policy information for a communication terminal from a second apparatus;

receiving, from the communication terminal, service request message including information for an application for the communication terminal;

checking, whether the information for an application for the communication terminal is consistent with the policy information for a communication terminal; and

sending, to the communication terminal, information related to rejection in a case where the information for an application for the communication terminal is not consistent with the policy information for a communication terminal.

### Supplementary Note 21.

A method for a first apparatus comprising:

storing policy information for a communication terminal from a second apparatus;

receiving, from the communication terminal, service request message including information for an application for the communication terminal;

checking, whether the information for an application for the communication terminal is consistent with the policy information for a communication terminal; and

sending, to the communication terminal, information related to acceptance in a case where the information for an application for the communication terminal is consistent with the policy information for a communication terminal.

### Supplementary Note 22.

A method for a first apparatus comprising:

storing policy information for a communication terminal from a second apparatus;

sending, to the communication terminal, a request message for information for an application for the communication terminal;

receiving, from the communication terminal, the information for an application for the communication terminal;

checking, whether the information for an application for the communication terminal is consistent with the policy information for the communication terminal; and

sending, to the communication terminal, information related to rejection in a case where the information for an application for the communication terminal is not consistent with the policy information for the communication terminal.

### Supplementary Note 23.

A method for a first apparatus comprising:

storing policy information for a communication terminal from a second apparatus;

sending, to the communication terminal, a request message for information for an application for the communication terminal;

receiving, from the communication terminal, the information for an application for the communication terminal;

checking, whether the information for an application for the communication terminal is consistent with the policy information

for the communication terminal; and sending, to the communication terminal, information related to acceptance in a case where the information for an application for the communication terminal is consistent with the policy information for the communication terminal.

### <Supplementary Notes 2>

### Supplementary Note 1.

A method for a User Plane Function (UPF) comprising:

receiving, from a core network node, at least one of Users Equipment ID (UE ID), Data Network Name (DNN), Single-Network Slice Selection Assistance Information (S-NSSAI) and information related to UE Route Selection Policy rule (URSP),

checking whether user data for a User Equipment (UE) using a User Equipment (UE) session with the DNN and S-NSSAI matches the information related to UE Route Selection Policy rule (URSP) or not; and

sending to the core network node a result of the checking.

### Supplementary Note 2.

The method according to supplementary note 1, wherein

the information related to the URSP includes time information and location information.

### Supplementary Note 3.

The method according to supplementary note 1, wherein

the information related to the URSP is used by the UPF to check whether a destination address of the user data matches the descriptors in the URSP rule or not.

### Supplementary Note 4.

The method according to supplementary note 1, wherein the information related to the URSP is used by the UPF to check whether a port number of the user data matches the descriptors in the URSP rule or not.

### Supplementary Note 5.

The method according to supplementary note 1, wherein the information related to the URSP is used by the UPF to check whether a protocol of the user data matches the descriptors in the URSP rule or not.

### Supplementary Note 6.

A User Plane Function (UPF) comprising:

a memory; and

at least one processor configured to access the memory and configured to:
receive, from a core network node, at least one of Users Equipment ID (UE ID), Data Network Name (DNN), Single-Network Slice Selection Assistance Information (S-NSSAI) and information related to UE Route Selection Policy rule (URSP);
check whether user data for a User Equipment (UE) using a User Equipment (UE) session with the DNN and S-NSSAI matches the information related to UE Route Selection Policy rule (URSP) or not; and
send to the core network node a result of the check.

### Supplementary Note 7.

The User Plane Function (UPF) according to supplementary note 6, wherein

the information related to the URSP includes time information and location information.

### Supplementary Note 8.

The User Plane Function (UPF) according to supplementary note 6, wherein

the information related to the URSP is used by the UPF to check whether a destination address of the user data matches the descriptors in the URSP rule or not.

### Supplementary Note 9.

The User Plane Function (UPF) according to supplementary note 6, wherein

the information related to the URSP is used by the UPF to check whether a port number of the user data matches the descriptors in the URSP rule or not.

### Supplementary Note 10.

The User Plane Function (UPF) according to supplementary note 6, wherein

the information related to the URSP is used by the UPF to check whether a protocol of the user data matches the descriptors in the URSP rule or not.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Indian provisional patent application No. 202211016661, filed on Mar. 24, 2022, the disclosure of which is incorporated herein in its entirety by reference.

### REFERENCE SIGNS LIST

1 telecommunication system
3 UE
5 (R)AN node
7 core network
20 data network
31 transceiver circuit
32 antenna
33 controller
34 user interface
35 USIM
36 memory
51 transceiver circuit
52 antenna
53 network interface
54 controller
55 memory
60 RU
61 DU
62 CU
70 AMF
71 SMF
72 UPF
73 PCF
74 AUSF
75 UDM
76 NWDAF
361 operating system
362 communications control module
363 application
551 operating system
552 communications control module
601 transceiver circuit
602 antenna
603 network interface
604 controller
605 memory
611 transceiver circuit
612 network interface
613 controller
614 memory
621 transceiver circuit
622 network interface
623 controller
624 memory
701 transceiver circuit
702 network interface
703 controller
704 memory
711 transceiver circuit
712 network interface
713 controller
714 memory
721 transceiver circuit
722 network interface
723 controller
724 memory
731 transceiver circuit
732 network interface
733 controller
734 memory
741 transceiver circuit
742 network interface
743 controller
744 memory
751 transceiver circuit
752 network interface
753 controller
754 memory
3621 transceiver control module
5521 transceiver control module
6051 operating system
6052 communications control module
6141 operating system
6142 communications control module
6241 operating system
6242 communications control module
7041 operating system
7042 communications control module
7141 operating system
7142 communications control module
7241 operating system
7242 communications control module
7341 operating system
7342 communications control module
7441 operating system
7442 communications control module
7541 operating system
7542 communications control module
36301 APP1
36302 APP2
60521 transceiver control module
61421 transceiver control module
62421 transceiver control module
70421 transceiver control module
71421 transceiver control module
72421 transceiver control module
73421 transceiver control module
74421 transceiver control module
75421 transceiver control module

What is claimed is:

1. A method for a Policy Control Function (PCF) comprising:
receiving, from a Session Management Function (SMF), at least one of a Data Network Name (DNN), Single Network Slice Selection Assistance Information (S-NSSAI) and information related to an application; and
checking whether the at least one of the DNN and the S-NSSAI are compliant to a UE Route Selection Policy rule (URSP rule).

2. The method according to claim 1 comprising:
updating the URSP rule based on the information related to an application in a case where the URSP rule is not a latest URSP rule.

3. The method according to claim 1 comprising:
updating the URSP rule in a User Equipment (UE) in a case where at least one of the DNN and the S-NSSAI are not compliant to the URSP rule.

4. The method according to claim 1, wherein
the receiving and the checking are related to a Protocol Data Unit session establishment (PDU session establishment) procedure.

5. The method according to claim 2 comprising:
receiving, from a User Equipment (UE), information related to URSP rule enforcement.

6. The method according to claim 2, wherein
the DNN and the S-NSSAI are sent from a User Equipment (UE).

7. The method according to claim 5 comprising:
checking the information related to the URSP rule enforcement based on the information relate to an application.

8. A Policy Control Function (PCF) comprising:
a memory; and
at least one processor configured to access the memory and configured to:
receive, from a Session Management Function (SMF at least one of a Data Network Name (DNN), Single Network Slice Selection Assistance Information (S-NSSAI) and information related to an application; and
check whether the at least one of the DNN and the S-NSSAI are compliant to a UE Route Selection Policy rule (URSP rule).

9. The PCF according to claim 8 wherein
the processor is configured to update the URSP rule based on the information related to an application in a case where the URSP rule is not a latest URSP rule.

10. The PCF according to claim 8 wherein
the processor is configured to update the URSP rule in a User Equipment (UE) in a case where at least one of the DNN and the S-NSSAI are not compliant to the URSP rule.

11. The PCF according to claim 8, wherein
the receiving and the checking are related to a Protocol Data Unit session establishment (PDU session establishment) procedure.

12. The PCF according to claim 9 wherein
the processor is configured to receive, from a User Equipment (UE), information related to URSP rule enforcement.

13. The PCF according to claim 9, wherein
the DNN and the S-NSSAI are sent from a User Equipment (UE).

14. The PCF according to claim 12 wherein
the processor is configured to check the information related to the URSP rule enforcement based on the information relate to an application.
